(19) United States
(12) Patent Application Publication
(10) Pub. No.: US 2023/0136508 A1
(43) Pub. Date: May 4, 2023

(54) Systems and Methods to Preserve Wildlife and Enable Remote Wildlife Tourism

(71) Applicant: Themba Inc., San Carlos, CA (US)

(72) Inventors: Matthew Rabinowitz, San Carlos, CA (US); Margot Eiran, San Carlos, CA (US); Noah Callaway, San Carlos, CA (US); Ori Eiran, San Carlos, CA (US); Omer Lev, San Carlos, CA (US); Jonathan Sheena, San Carlos, CA (US)

(21) Appl. No.: 18/054,891

(22) Filed: Nov. 12, 2022

Related U.S. Application Data
(63) Continuation of application No. PCT/US2021/032011, filed on May 12, 2021.
(60) Provisional application No. 63/024,695, filed on May 14, 2020.
(60) Provisional application No. 63/023,524, filed on May 12, 2020.

(51) Int. Cl. G06Q 50/14; H04N 7/18; G06V 20/17; H04N 5/77; G06V 40/10; G05D 1/00; G09B 5/02; G09B 5/06; G06Q 10/02

(52) U.S. Cl. CPC G06Q 50/14; H04N 7/183; G06V 20/17; H04N 5/77; G06V 40/10; G05D 1/0094; G09B 5/02; G09B 5/065; G06Q 10/02

(57) ABSTRACT

Systems and methods to preserve wildlife and enable remote wildlife tourism are described. A system for a remote wildlife viewing includes a memory and a processor. The processor is configured to control a set of one or more drones with cameras. The processor is configured to enable a user to log onto one or more of the drones to capture one or more wildlife images using one or more of the cameras. The processor is configured to display the one or more wildlife images on a user device.

### RELATED APPLICATIONS

The subject matter of this application is related to Patent Cooperation Treaty Application PCT/US2021/032011, filed on May 12, 2021, U.S. provisional patent application number 63/024,695, filed May 14, 2020, and U.S. provisional patent application number 63/023,524 filed May 12, 2020, all of which are incorporated herein by reference in their entirety.

### FIELD

Embodiments of the invention relate to nature conservation, and more specifically, to preserving wildlife and enabling remote wildlife tourism.

### BACKGROUND

Generally, wildlife conservation refers to the practice of protecting wild species and their habitats to maintain healthy wildlife species or populations and to restore, protect and/or enhance natural ecosystems. Major threats to wildlife include human-caused habitat destruction, degradation, fragmentation, overexploitation, poaching, pollution and climate change. Habitat destruction and fragmentation can increase the vulnerability of wildlife populations by reducing the space and resources available to them and by increasing the likelihood of conflict with humans. An increasing number of ecosystems on Earth contain endangered species that are at risk for extinction. Overexploitation takes place when harvesting of animals and plants occurs at a rate that is faster than the species' ability to recover. The overexploitation leads to a decline in species' sizes and species' numbers.

Poaching for illegal wildlife trading is a major threat to certain species, particularly endangered ones whose status makes them economically valuable. Such species include many large mammals like African elephants, tigers, and rhinoceroses that are traded for their tusks, skins, and horns respectively. Less well-known targets of poaching include the harvest of protected plants and animals for souvenirs, food, skins, pets, and more. Because poachers tend to target threatened and endangered species, poaching causes already small populations to decline even further. There are national and international governmental efforts made to preserve wildlife and wildlife habitats.

Generally, an unmanned aerial vehicle (UAV), commonly known as a drone, is an aircraft without a human pilot on board. The flight of UAVs may operate under remote control by a human operator or with various degrees of autonomy, such as autopilot assistance, up to fully autonomous aircraft that does not allow human intervention.

### SUMMARY

Systems and methods to preserve wildlife and enable remote wildlife tourism are described. In at least some embodiments, a system for a remote wildlife viewing comprises a memory and a processor. The processor is configured to control a set of one or more drones with cameras. The processor is configured to enable a user to log onto one or more of the drones to capture one or more wildlife images using one or more cameras of the drones. The processor is configured to display the one or more wildlife images on a user device.

The processor may be further configured to receive one or more commands from the user to control at least one of the one or more of the drones and the one or more of the cameras and receive wildlife image data captured by the one or more of the cameras in response to the one or more commands. The processor may be further configured to identify a wildlife organism based on the one or more wildlife images using a neural network technique. The processor may be configured to enable the user to log onto the one or more of the drones for a predetermined time. The processor may be configured to assign a score to the user based on the one or more wildlife images. The processor may be configured to control locations of the drones using a geo-fencing technique. The processor may be configured to monitor a power of the drones. The processor may be configured to monitor an allotted flight time of the drones. The processor may be configured to receive information identifying the user. The processor may be configured to receive a recorded wildlife image from the user to prevent an illegal activity. The processor may be configured to generate a map indicating at least one of a location of the user, a location of other users and a location at which the one or more wildlife images are captured. The processor may be configured to display an educational material associated with the one or more wildlife images on the user device. The processor may be configured to split a revenue from a user booking time on the system with a conservancy. The processor may be configured to send data including at least one of a location and a status of the one or more drones to a conservancy. The processor may be configured to generate a map including a movement pattern of a wildlife organism in an area based on data from the user. The processor may be configured to receive a request to book a flight at a predetermined time; receive a selection of a conservation location; receive a payment for the flight; and generate a notification about the flight to send to the user. The processor may be configured to generate a user interface to provide the remote wildlife viewing on the user device. The processor may be configured to generate a flight tutorial video on the user device. The processor may be configured to determine that the user is authorized to use the one or more of the drones. The processor may be configured to generate a map indicating a location of a drone assigned to the user relative to a geo-fenced area. The processor may be configured to generate a profile associated with the user and store the profile in a memory. The processor may be configured to calculate a flight statistics and store the flight statistics in a memory. The processor may be configured to share a user stream associated with a flight with another user. The processor may be configured to determine/select a drone of the one or more drones for the user.

In at least some embodiments, an apparatus for remote wildlife viewing may comprise one or more cameras and a processor coupled to the one or more cameras. The processor may be configured to receive an indication that a user is enabled to log onto the apparatus; receive one or more commands to capture wildlife images for the user; capture wildlife images using one or more of the cameras in response to the one or more commands; and send the one or more wildlife images to display on a user device. The apparatus may comprise a housing coupled to the processor. The apparatus may comprise a helium balloon coupled to the housing. The apparatus may comprise a mesh surrounding the housing to protect a wildlife. The apparatus may comprise one or more speakers coupled to the processor to create a destructive interference for a sound emanating from the apparatus. The apparatus may comprise a microphone coupled to the processor. The apparatus may comprise a docking port coupled to the processor.

In at least some embodiments, an apparatus to detect a wildlife contra-ban may comprise a memory; and a processor coupled to the memory. The processor may be configured to collect data associated with a wildlife; identify a wildlife contra-ban based on the collected data; and generate a notification regarding the wildlife contra-ban. The processor may comprise one or more sensors coupled to the processor to detect molecules associated with the wildlife. The wildlife contra-ban can be identified based on the detected molecules associated with the wildlife. The data may be online sales data. The wildlife contra-ban may be identified based on the online sales data.

In at least some embodiments, a system to monitor individual animals in a conservation area may comprise a memory and a processor coupled to the memory. The processor may be configured to receive a selection of an animal, retrieve data associated with the selected animal from a database, and generate a map including one or more paths indicating a movement of the selected animal. The processor may be configured to collect data from rangers including at least one of a location and an identifier of the animal, store the data in a database and generate a profile for the animal based on the data. The processor may be configured to receive a selection of at least one of an area and a data range associated with the animal. The processor may be configured to compare a captured wildlife image of the animal with a stored wildlife image of the animal using an image recognition technique. The processor may be configured to generate a notification when the animal is moved outside of an area.

In at least some embodiments, a system to monitor a conservation area border may comprise one or more sensors and a processor coupled to the one or more sensors. The processor may be configured to scan the conservation area border to capture wildlife images using the one or more sensors, identify an illegal border crossing from the wildlife images, and generate a notification regarding the illegal border crossing. The processor may be configured to scan the conservation area border using a satellite telescope border protection mechanism coupled to the one or more sensors. The one or more sensors may comprise one or more LiDAR sensors.

In at least some embodiments, a method for remote wildlife viewing is described. A set of one or more drones with cameras are controlled. A user is enabled to log onto one or more of the drones to capture one or more wildlife images using one or more of the cameras. The one or more wildlife images are displayed on a user device. In at least some embodiments, one or more commands may be received from the user to control at least one of the one or more of the drones and the one or more of the cameras. Wildlife image data captured by the one or more of the cameras may be received in response to the one or more commands. A wildlife organism may be identified based on the one or more wildlife images using a neural network technique. The user may be enabled to log onto the one or more of the drones for a predetermined time. A score may be assigned to the user based on the one or more wildlife images. Locations of the drones may be controlled using a geo-fencing technique. A power of the drones may be monitored. An allotted flight time of the drones may be monitored. Information identifying the user may be received. A recorded wildlife image may be received from the user to prevent an illegal activity. A map indicating at least one of a location of the user, a location of other users and a location at which the one or more wildlife images are captured may be generated. An educational material associated with the one or more wildlife images may be displayed on the user device. A revenue from a user booking time on the system may be split with a conservancy. Data comprising at least one of a location and a status of the one or more drones is sent to a conservancy. A map comprising a movement pattern of a wildlife organism in an area may be generated based on data from the user. A request to book a flight at a predetermined time is received. A selection of a conservation location may be received. A payment for the flight may be received. A notification about the flight to send to the user is generated. A user interface to provide the remote wildlife viewing on the user device may be generated. A flight tutorial video may be generated on the user device. It may be determined that the user is authorized to use the one or more of the drones. A map indicating a location of a drone assigned to the user relative to a geo -fenced area may be generated. A profile associated with the user may be generated and stored in a memory. One or more flight statistics may be calculated and stored in a memory. A user stream associated with a flight may be shared with other user. A drone of the one or more drones is determined/selected for the user.

In at least some embodiments, a method for remote wildlife viewing is described. An indication that a user is enabled to log onto a drone is received. One or more commands to capture wildlife images for the user are received. Wildlife images are captured using one or more of the cameras in response to the one or more commands. The one or more wildlife images are sent to display on a user device. In at least some embodiments, the drone may comprise a processor; a housing coupled to the processor; a helium balloon coupled to the housing; a mesh surrounding the housing to protect a wildlife; one or more speakers coupled to the processor to create a destructive interference for a sound emanating from the drone; a microphone coupled to the processor and a docking port coupled to the housing.

In at least some embodiments, a method to detect a wildlife contra-ban is described. Data associated with a wildlife organism are detected. A wildlife contra-ban is detected based on the collected data. A notification is generated regarding the wildlife contra-ban. Molecules associated with the wildlife organism may be detected using one or more sensors. The wildlife contra-ban may be identified based on the detected molecules associated with the wildlife organism. The data may be online sales data. The wildlife contra-ban may be identified based on the online sales data.

In at least some embodiments, a method to monitor individual animals in a conservation area is described. A selection of an animal is received. Data associated with the selected animal are retrieved from a database. A map comprising one or more paths indicating a movement of the selected animal is generated. Data from rangers including at least one of a location and an identifier of the animal may be collected. The collected data may be stored in a database. A profile for the animal may be generated based on the collected data. A selection of at least one of an area and a data range associated with the animal may be received. A captured wildlife image of the animal may be compared with a stored wildlife image of the animal using an image recognition technique. A notification when the animal is moved outside of an area may be generated.

In at least some embodiments, a method to monitor a conservation area border is described. The conservation area border is scanned to capture wildlife images using one or more sensors. An illegal border crossing is identified from the wildlife images. A notification regarding the illegal border crossing is generated. The conservation area border may be scanned using a satellite telescope border protection mechanism coupled to the one or more sensors. The one or more sensors may include one or more LiDAR sensors.

In at least some embodiments, a non-transitory machine readable medium comprises instructions that cause a data processing system to perform methods for remote wildlife viewing as described herein.

In at least some embodiments, a non-transitory machine readable medium comprises instructions that cause a data processing system to perform methods to detect a wildlife contra-ban as described herein.

In at least some embodiments, a non-transitory machine readable medium comprises instructions that cause a data processing system to perform methods to monitor individual animals in a conservation area as described herein.

In at least some embodiments, a non-transitory machine readable medium comprises instructions that cause a data processing system to perform methods to monitor a conservation area border as described herein.

Other systems, methods, and machine-readable mediums to preserve wildlife and enable remote wildlife tourism are also described.

### BRIEF DESCRIPTION OF THE DRAWINGS

Embodiments of the invention may best be understood by referring to the following description and accompanying drawings that are used to illustrate embodiments of the invention. In the drawings:

FIG. 1A is a diagram illustrating a system for a remote wildlife viewing according to one embodiment.

FIG. 1B is a block diagram illustrating a data processing system for a remote wildlife viewing according to one embodiment.

FIG. 1C is a block diagram illustrating a system for a remote wildlife viewing according to one embodiment.

FIG. 2A is a flowchart of a method to provide a remote wildlife viewing according to one embodiment.

FIG. 2B is a flowchart of a method 210 to provide a remote wildlife viewing according to one embodiment.

FIG. 3A is a flowchart of a method to provide a remote wildlife viewing according to one embodiment.

FIG. 3B is a diagram illustrating a user interface for a remote wildlife viewing according to one embodiment.

FIG. 4 is a flowchart of a method to detect a wildlife contra-ban according to one embodiment.

FIG. 5 is a flowchart of a method to monitor individual animals in a conservation area according to one embodiment.

FIG. 6 is an example of a data structure that includes data associated with the animals collected from rangers according to one embodiment.

FIG. 7 is a flowchart of a method to monitor individual animals in a conservation area according to one embodiment.

FIG. 8 is a diagram illustrating a map indicating a movement of animals according to one embodiment.

FIG. 9 is a flowchart of a method to monitor a conservation area border according to one embodiment.

FIG. 10 is a block diagram of a data processing system in accordance with one embodiment.

FIG. 11 illustrates a setup for simulation of active noise cancellation to determine speaker amplitude and phase according to one embodiment.

FIG. 12A shows a mesh plot amplitude of the signal on the surface of the sphere, as a function of spherical coordinate angles phi and theta, without a compensation signal according to one embodiment.

FIG. 12B shows a mesh plot amplitude of the signal on the surface of the sphere, as a function of spherical coordinate angles phi and theta, with the approximately optimal compensation signal of A=3.71 and ρ=3.14 according to one embodiment.

FIG. 13A shows a mesh plot of sound amplitude on an x-y plane without a compensation signal according to one embodiment.

FIG. 13B shows a mesh plot of sound amplitude on an x-y plane with a compensation signal according to one embodiment.

FIG. 14A shows a mesh plot of sound amplitude on an x-z plane without a compensation signal according to one embodiment.

FIG. 14B shows a mesh plot of sound amplitude an x-z plane with a compensation signal according to one embodiment.

### DETAILED DESCRIPTION

Systems and methods to preserve wildlife and enable remote wildlife tourism are described.

In at least some embodiments, a system for a remote wildlife viewing includes a memory and a processor. The processor is configured to control a set of one or more drones with cameras. The processor is configured to enable a user to log onto one or more of the drones to capture one or more wildlife images using one or more of the cameras. The processor is configured to display the one or more wildlife images on a user device. The processor is coupled to a set of one or more drones with cameras that advantageously enables viewing of animals online by users who log onto the system and are able to control a drone, a camera or both the drone and the camera.

In at least some embodiments, the system for a remote wildlife viewing lets people or groups of people—e.g., parents with their children—rent time on cameras that they can control anywhere online to watch, zoom in on or monitor animals. This is particularly important when conservancies have limited tourism, for example due to travel restrictions resulting from the COVID19 pandemic. In one embodiment the system for a remote wildlife viewing enables people with an Internet connection to rent time on remote-controlled drones, or blimps, which are drones using gas balloons to stay aloft with less power and noise than a conventional drone, to search for animals in conservation areas.

In the application the terms “drones” and “blimps”, “vehicles” are used interchangeably. The system for a remote wildlife viewing advantageously enables conservancies to generate more income, raises awareness around the world, and gives parents something fun and educational to do with their children.

In at least some embodiments, the described systems and methods advantageously prevent the destruction and sale of wildlife and enable money to be made from conservation activities. In at least some embodiments, the disclosed techniques are performed automatically without human intervention. Although the following examples and embodiments address preserving wildlife and enabling remote wildlife tourism, such techniques can be applied to any type of environment that would benefit from remote viewing.

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, or characteristic described in conjunction with the embodiment can be included in at least one embodiment. The appearances of the phrases “in one embodiment”, “in at least some embodiments”, “in an embodiment” in various places in the specification do not necessarily all refer to the same embodiment(s). The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

In the application, the term “and/or” generally describes an association relationship between associated objects and indicates that three relationships may exist. For example, A and/or B may represent only A, only B, or both A and B. Each of A and B may represent a singular object or a plurality of objects.

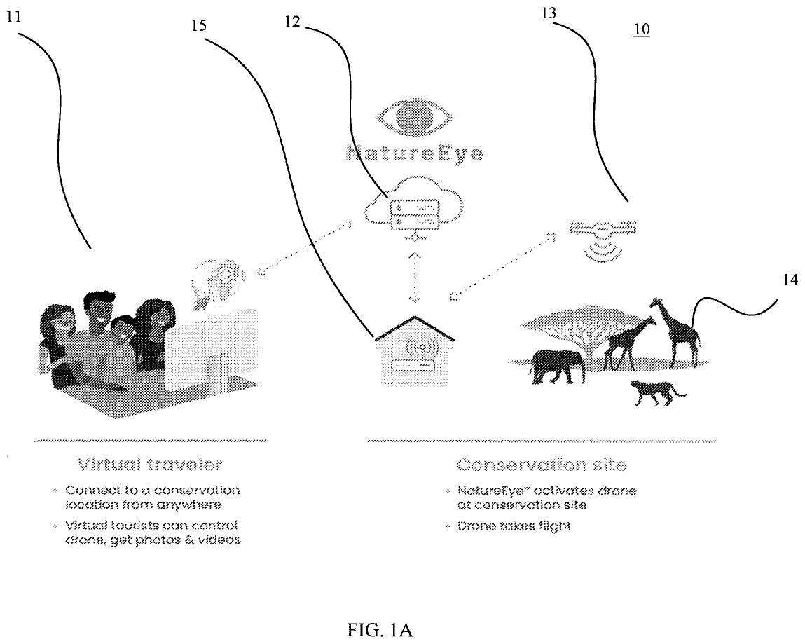

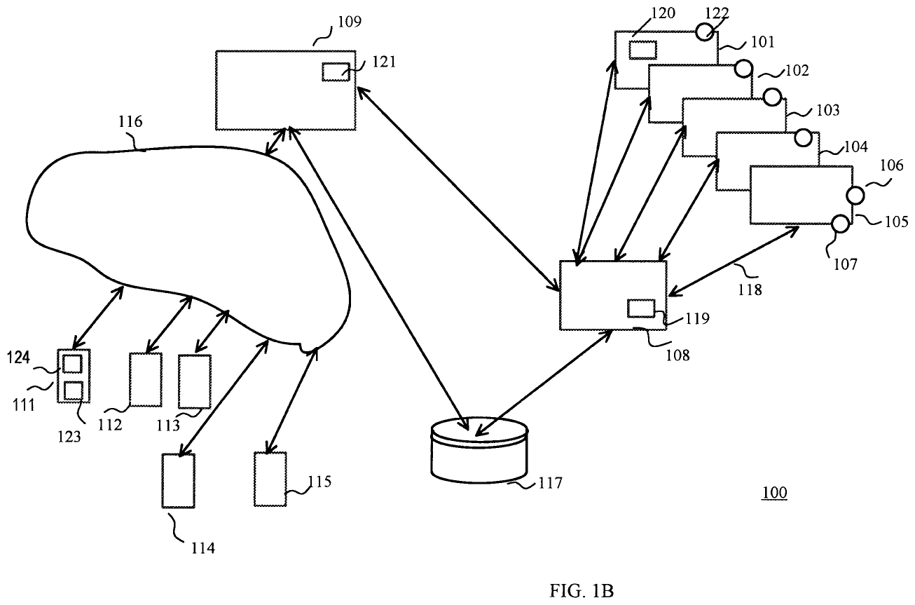

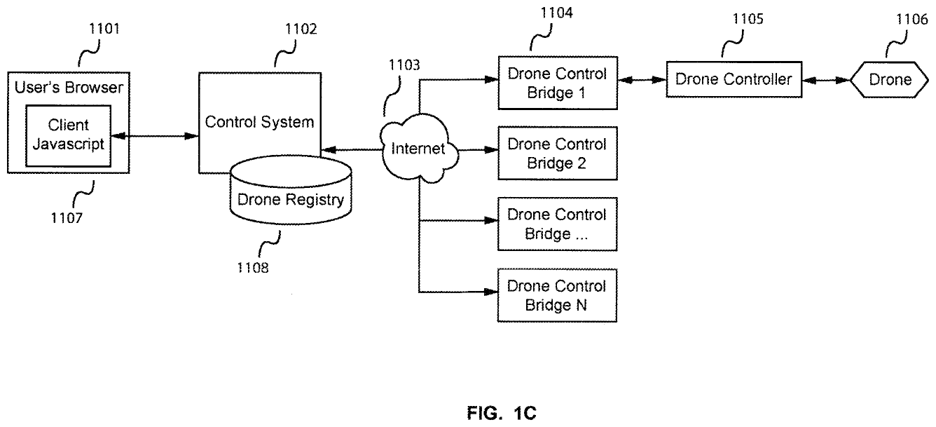

FIG. 1A is a diagram 10 illustrating a system for a remote wildlife viewing according to one embodiment. A person (virtual traveler) 11 based anywhere in the world can choose a conservation location 14 from a list of conservation locations and book a time slot (e.g., 30 about minutes, or other time slot) to fly a drone 13 at the chosen location. When the virtual traveler 11 connects to their booked drone via a website, a signal is sent through the cloud 12 to a communication hub 15 at the conservation location 14 and on to the drone 13. The virtual tourist is able to command the drone for a predetermined portion of the flight time (e.g., about 25 minutes, or other predetermined time), record videos and take photographs with a high-quality zoom camera coupled to the drone 13.

In one embodiment, the video provided by the drone is in a format that is friendly to be delivered to a web browser (e.g., Chrome™, Firefox™, Safari™, Edge™, or other web browser) via a video embed. In one embodiment, the video has an appropriate format, a video encoding, an audio encoding, a frame rate, and a resolution that is appropriate to the web browser. In one embodiment, the video provided by the drone is transcoded to the format that is appropriate the web browser. During a remaining portion of the flight time the drone 13 automatically returns to a base station for recharging.

FIG. 1B is a block diagram illustrating a data processing system 100 for a remote wildlife viewing according to one embodiment. Data processing system 100 includes a set of an autonomous driving (AD) vehicles. In one embodiment, the set of vehicles includes drones, such as a drone 101, a drone 102, a drone 103, a drone 104 and a drone 105, or other vehicles, e.g., cars, trucks, trains, boats, space crafts, or any other AD vehicles.

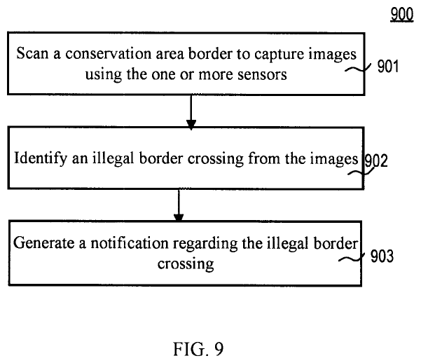

As shown in FIG. 1, a drone 101 includes a memory (not shown), a processor 120 coupled to the memory, and one or more cameras (e.g., a camera 122) coupled to the processor 201 to perform the methods to preserve wildlife and/or enable remote wildlife tourism as described in further detail herein. In at least some embodiments, the drones with cameras are remotely controlled. In at least some embodiments, the drones with cameras have pointing function and zoom functions. In at least some embodiments, the drones with cameras have location capabilities using Global Positioning System (GPS), Global Navigation Satellite System (GLONASS) or other location technology. In at least some embodiments, the drones with cameras are remotely controlled to enable viewing wildlife (e.g., animals, plants) online and/or crowd-sourced tracking. In at least some embodiments, a drone has one or more sensors, such as a sensor 106 coupled to one or more cameras, such as a camera 107. In at least some embodiments, the sensor is a Light Detection and Ranging (LiDAR) sensor, a radar sensor, an ultrasonic sensor, a global positioning system (GPS) sensor, other sensor, or any combination thereof. In at least some embodiments, the one or more sensors, such as a sensor 106 are coupled to geostationary satellite passive or active sensors to monitor conservation borders, as described in further detail below with respect to FIG. 9.

In at least some embodiments, the drone has a flight time enabling a user to take the drone to a viewing location of interest, spend a significant time there, and return the drone to a location where the drone is recharged. In at least some embodiments, the drone has a flight time that exceeds 15 minutes. In at least some embodiments, the drone generates as low noise as possible, because noise may disturb animals or people who are at the location. For example, the sound of drones similar to bees can disturb animals such as elephants. In at least some embodiment, the drone sound is reduced at the location using active sound reduction speakers. In at least some embodiment, the drone sound is digitally filtered out for users that want to hear sound excluding the drone, as discussed in further detail below. In at least some embodiments, the drones are managed by a collision avoidance system. In at least some embodiments, the drones are automatically geo-fenced. In at least some embodiments, the drones include cages to cover the propellers to prevent damage to wildlife, e.g., birds.

As shown in FIG. 1B, system 100 includes a communication hub 108 that connects with the drones 101-106 via communication links (e.g., a communication link 118) in the region of the conservancy. The communication hub 108 is coupled to a data storage device 117 via a network. In at least some embodiments, the storage device 117 is a computer memory, a database, a cloud, or a combination thereof. The communication hub 108 includes a memory (not shown) and one or more processors (e.g., a processor 119) coupled to the memory to perform the methods to preserve wildlife and enable remote wildlife tourism as described in further detail below. In at least some embodiments, the communication between the drones 101-106 and hub 108 is performed using a WIFI, IEEE 802.11, or other modulation protocol on frequencies roughly in an approximate range of 2.4 GHz, 5 GHz, or other frequency ranges. In at least some embodiments, a communication hub 108 broadcasts at a power that is greater than a power that is typically allowed by the 802.11 protocols (e.g., greater than 10 Watts) to achieve coverage over a distance of in an approximate range of 5 km to 10 km, or more than 10 km. In at least some embodiments, the communication between the drones 101-106 and hub 108 is performed using the WiMax or IEEE 802.16 standard which enables communication links of over a mile, and which enables link speeds in an approximate range of 40 Mbit/s to 1 Gbit/s with latencies of about 1 ms. In at least some embodiments, the communication between the drones 101-106 and hub 108 is performed using 3G, 4G or 5G cellular modems on the drones connecting to cellular base stations. In at least some embodiments, the communication hub 108 has a high-speed low-latency connection to communicate with an application server via the Internet. In at least some embodiments, the communication hub 108 uses a satellite link, such as Ka-Ku band, in regions where there is no ready Internet access to connect to an application server. In at last some communication links (e.g., a communication link 118) have low latency and sufficient bandwidth for high quality video.

As shown in FIG. 1B, system 100 comprises an application server system 109 coupled to communication hub 108 and a storage device 117. Application server system 109 is coupled to user devices (e.g., a user device 111, a user device 112, a user device 113, a user device 114 and a user device 115) via a computer network 116. In one embodiment, network 116 is the Internet. In one embodiment, network 116 is a local area network (LAN), or other communication network. In one embodiment, network 116 is a wireless network. In one embodiment, the application server system 109 is coupled to communication hub 108 and storage device 117 via a computer network, e.g., a Local Area Network (LAN), an intranet, an extranet, or the Internet. The application server system 109 includes a memory (not shown) and one or more processors (e.g., a processor 121) coupled to the memory that manages an application to perform the methods to preserve wildlife and enable remote wildlife tourism as described in further detail herein.

In at least some embodiments, a processor 121 is configured to enable an online user to fly a drone. In at least some embodiments, a processor 121 is configured to perform geo-fencing of the drones not to go outside the borders of the conservancy and/or above or below certain altitudes. In at least some embodiments, a processor 121 is configured to provide a flight plan and collision avoidance for the drones. In at least some embodiments, a processor 121 is configured to fly the drones automatically back to base stations for recharging. In at least some embodiments, a processor 121 is configured to enable people to log onto drones, schedule time on drones, collect and verify the government identity such as passport or driver's license, address and other information, of users to reduce the risk of their using the system for illegal purposes such as poaching. In at least some embodiments, a processor 121 is configured to keep track of which users have been in the area of certain animals at what time to prevent poaching. In at least some embodiments, a processor 121 is configured to communicate with the conservancy, manage payments to the conservancy, send out communications such as emails to users and/or perform other operations.

As shown in FIG. 1B, system 100 includes user devices (e.g., user devices 111-115). A user device 111 includes a memory (not shown) and one or more processors (e.g., a processor 124) coupled to the memory to perform the methods to preserve wildlife and enable remote wildlife tourism as described in further detail below. A web user interface (e.g., a web user interface 123) coupled to the processor on a user device may be used to perform one or more of the following functions: remotely control the drones; view, direct and zoom the cameras; take photographs and/or videos of the wildlife; compare the species, individuals, or both species and individuals spotted with a list of animals in the conservancy; contribute to research such as recording the location of animals; use automatic image identification tools to identify the animals, species, or both animals and species; report suspicious activities such as poachers; and other functions that enable contributions to online communities. In at least some embodiments, the user device may be a laptop computer, a netbook computer, a notebook computer, an ultrabook computer, a smartphone, a tablet, a personal digital assistant (PDA), an ultra mobile PC, a mobile phone, a desktop computer, or any other electronic device that processes data.

FIG. 1C is a block diagram illustrating a system 1100 for a remote wildlife viewing according to one embodiment. As shown in FIG. 1C, a system 1100 comprises a client that is a client Javascript™ 1107 operating in a user's browser 1101, and a control system 1102 coupled to a drone registry 1108. In one embodiment, drone registry 1108 represents a database comprising a registry of the drones. A control system 1102 is coupled to drone control bridges, such as a drone control bridge 1104 via a network 1103, e.g., the Internet. Drone control bridges are coupled to drones, such as a drone 1106 via drone controllers, such as a drone controller 1105. In one embodiment, the drone control system is a system that is coupled to one or more backend application servers that allows the users to control a drone. In one embodiment, the drone control bridge comprises a processor that is configured to accept drone commands and control the drone. In one embodiment, the system for a remote wildlife viewing comprises a reservation system comprising a processor (not shown) that is coupled to the application server that is configured to allow users to schedule or book a flight. In one embodiment, the flight is associated with a reservation for an end user, time, a drone, and a location. In one embodiment, a drone comprises a physical drone hardware, as described in further detail herein. In one embodiment, an end user refers to a human that is controlling a drone using a processor. In one embodiment, the system for a remote wildlife viewing comprises one or more authentication systems comprising one or more processors that are configured to provide authentication services for users, as described in further detail herein.

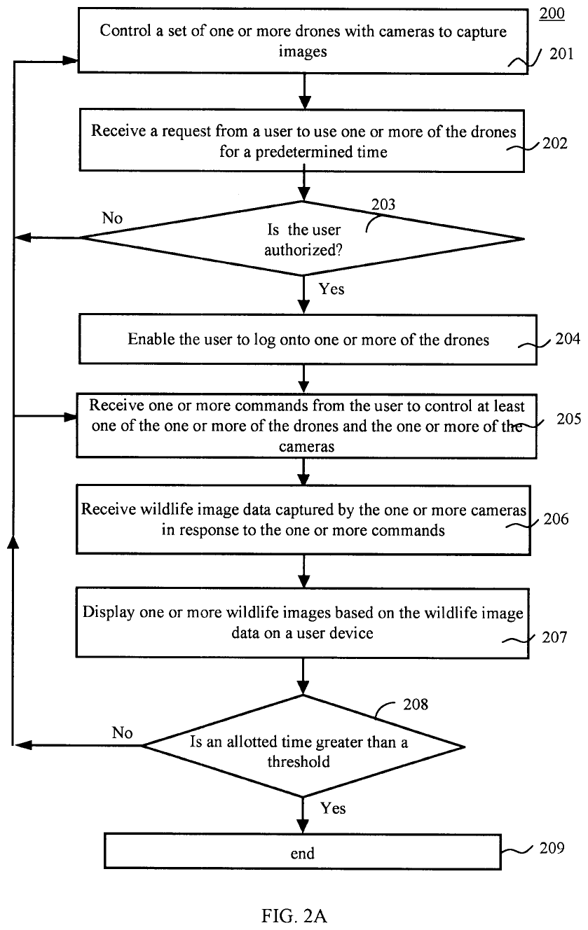

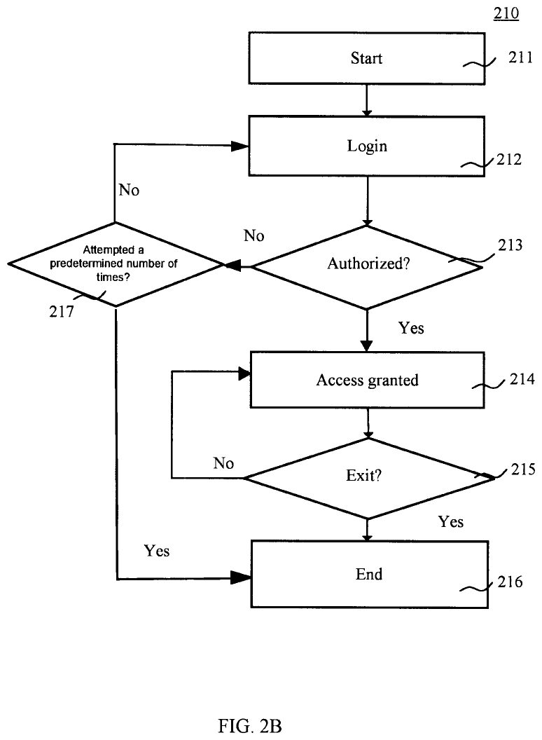

FIG. 2A is a flowchart of a method 200 to provide a remote wildlife viewing according to one embodiment. In one embodiment, the method 200 is performed at an application server system, e.g., an application server system 109. In another embodiment, the method 200 is performed at a communication hub, e.g., a communication hub 108. The method 200 begins at an operation 201 that involves controlling a set of one or more drones with cameras that are used to capture images. In one embodiment, locations of the drones are controlled using a geo-fencing technique. In one embodiment, the processor of the remote wildlife viewing system generates a map indicating a location of a drone relative to a geo-fenced area, as described in further detail herein.

In one embodiment, power of the drones is monitored. In one embodiment, the flight of the drone is monitored to determine a drone failure, e.g., a drone collision with other object (e.g., another drone, a tree, or any other object), a communication lost, or other failure, and to generate an alarm to notify a user.

At an operation 202 a request is received from a user to use one or more of the drones for a predetermined time. In one embodiment, the request includes information identifying the user. In one embodiment, the user is coupled to one or more drones via an application server 109, a communication hub 108, or both the application server and the communication hub. In one embodiment, the request for the remote wildlife viewing is received from a user via a user interface displayed on the user device. In one embodiment, the processor of the remote wildlife viewing system generates a flight tutorial video on the user interface.

In one embodiment, the request comprises a request to book a flight at a predetermined date and/or time. In one embodiment, the processor of the remote wildlife viewing system receives a selection of a conservation location from the user via the user interface. In one embodiment, the processor of the remote wildlife viewing system receives a payment for the flight via the user interface. In one embodiment, the payment for the flight is received using a Stripe™ payment system. In another embodiment, the payment for the flight is received using a PayPal™ payment system, or other payment system. In one embodiment, a notification (alert) about the flight at the predetermined date and time is generated and sent to the user.

At an operation 203 it is determined if the user is authorized to use the one or more of the drones. In one embodiment, the processor of the remote wildlife viewing system performs a user authentication using one or more user authentication techniques, e.g., an Auth0 authentication, a PassportJS™ authentication, Login with Google™ other user authentication techniques, or any combination thereof. If it is determined that the user is not authorized to use the one or more of the drones, method 200 returns back to operation 201. If it is determined that the user is authorized to use the one or more of the drones, at an operation 204 the user is enabled to log onto the one or more of the drones to capture one or more wildlife images using one or more of the cameras. In one embodiment, the processor of the remote wildlife viewing system determines a drone of the one or more drones for the user. In one embodiment, a number of drones and types of drones at the conservation location selected by the user are determined. In one embodiment, available time slots are determined for the selected conservation location. In one embodiment, a drone is assigned to the user based on the determined number of drones and types of drones and the available time slots. In one embodiment, the user is enabled to log onto the one or more of the drones for a predetermined time. In one embodiment, an allotted flight time of the drone is monitored.

At an operation 205 one or more commands are received from the user to control at least one of the one or more of the drones and the one or more of the cameras. At an operation 206 wildlife image data captured by the one or more cameras in response to the one or more commands are received. In one embodiment, a wildlife organism is identified based on the one or more wildlife images using a neural network technique. In one embodiment, a recorded wildlife image is received from the user to prevent an illegal activity. At an operation 207 one or more wildlife images are displayed based on the wildlife image data on a user device, such as a user device 111. In one embodiment, a score is assigned to the user based on the one or more wildlife images.

In one embodiment, a processor of the drone control system (e.g., a processor 119, a processor 120, or other processor) stores the raw media (e.g., images, video, or both the images and video) from the flights to a permanent storage (e.g., storage device 117) that is accessible from a processor of the application server system (e.g., a processor 12). In one embodiment, a processor of the remote wildlife viewing system (e.g., a processor 119, a processor 120, a processor 121, or other processor) generates post-flight statistics that comprise one or more flight parameters. In one embodiment, a flight parameters is a flight altitude, a flight speed, a flight distance, a flight time, other flight parameter, or any combination thereof In one embodiment, a total flight parameter is calculated as a sum of values of the flight parameter associated with individual flights.

In one embodiment, the post-flight statistics comprise an individual flight distance, an individual flight time, a sum of individual flight distances (total flight distance), a sum of individual flight times (total flight time), a maximum value of the flight parameter, a median value of the flight parameter, other flight statistics, or any combination thereof In one embodiment, the post-flight statistics are stored in a memory. In one embodiment, one or more individual post-flight statistics are tracked.

In one embodiment, the processor of the remote wildlife viewing system generates a profile associated with the user and stores the profile in a memory. In one embodiment, the profile associated with the user comprises data associated with user information, flight information, media information, or any combination thereof. In one embodiment, the user information comprises a user email, phone number, name, password, avatar, or any combination thereof. In one embodiment, the flight information comprises a number of flights, a distance travelled, a flight time, other flight statistics, or any combination thereof. In one embodiment, the media information comprises a photo count, a video count, other media statistics, or any combination thereof. In one embodiment, updated user information is received and the user profile is adjusted based on the updated user information. In one embodiment, updated flight information is received and the user profile is adjusted based on the updated flight information. In one embodiment, updated media information is received and the user profile is adjusted based on the updated media information.

In one embodiment, the processor of the remote wildlife viewing system shares a user stream associated with a flight with one or more other users. In one embodiment, the processor of the remote wildlife viewing system is configured to generate a shareable URL where a given flight is publicly streamed. In one embodiment, the processor of the remote wildlife viewing system is configured to create a public stream page or to share that page into various social applications. In one embodiment, the processor of the remote wildlife viewing system is configured to provide a guide experience in which a guide views a user's stream and interacts with the user using a text chat, voice chat, or both a voice and text chat. In one embodiment, the processor of the remote wildlife viewing system is configured to generate a user interface to receive a public review about the flight. The public review may comprise, for example, a star rating and/or a comment field.

In one embodiment, a map indicating at least one of a location of the user, a location of other users and a location at which the one or more wildlife images are captured is generated. In one embodiment, a map including a movement pattern of a wildlife organism in an area is generated based on data from the user. In one embodiment, an educational material associated with the captured one or more wildlife images is displayed on the user device. At an operation 208 it is determined: is an allotted time greater than a predetermined time threshold. If the allotted time is not greater than the predetermined time threshold, the method 200 returns to operation 205. If the allotted time is greater than the predetermined time threshold, the method 200 ends. In one embodiment, a revenue generated from a user booking time on the system is split with a conservancy. In one embodiment, data including a location of one or more drones, a status of the one or more drones, or both the location and the status are sent to a conservancy, as described in further detail herein.

FIG. 2B is a flowchart of a method 210 to provide a remote wildlife viewing according to one embodiment. At operation 211 the method starts. At operation 212 login information is received from a user. In one embodiment, the login information comprises a user identifier (ID), a password, other user login information, or any combination thereof. At operation 213 it is determined if the user is authorized to access the system for a remote wildlife viewing based on the login information. If it is determined that the user is not authorized to access the system, it is determined if a number of the user attempts to log into the system is greater than a predetermined number (e.g., three, or any other number). If the number of the user attempts is not greater than the predetermined number, method 210 returns to operation 212. If the number of the user attempts exceeds the predetermined number, the method 210 ends. If it is determined that the user is authorized, at operation 214 an access to the system for a remote wildlife viewing is granted. At operation 215 it is determined if an indication for the user to exit the system is received. If it is determined that the indication for the user to exit the system is not received, method 210 returns to operation 214. If it is determined that the indication for the user to exit the system is received, method 210 ends at operation 214.

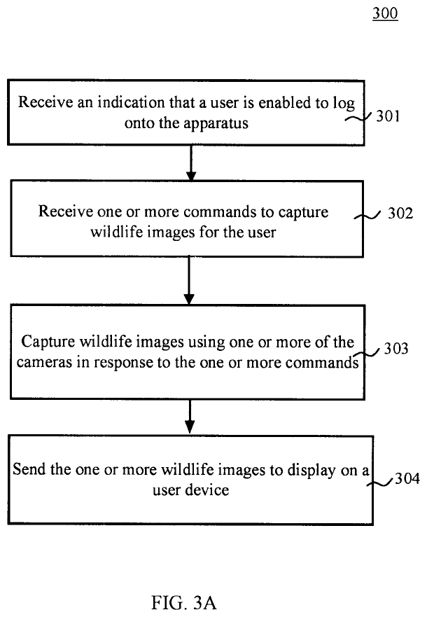

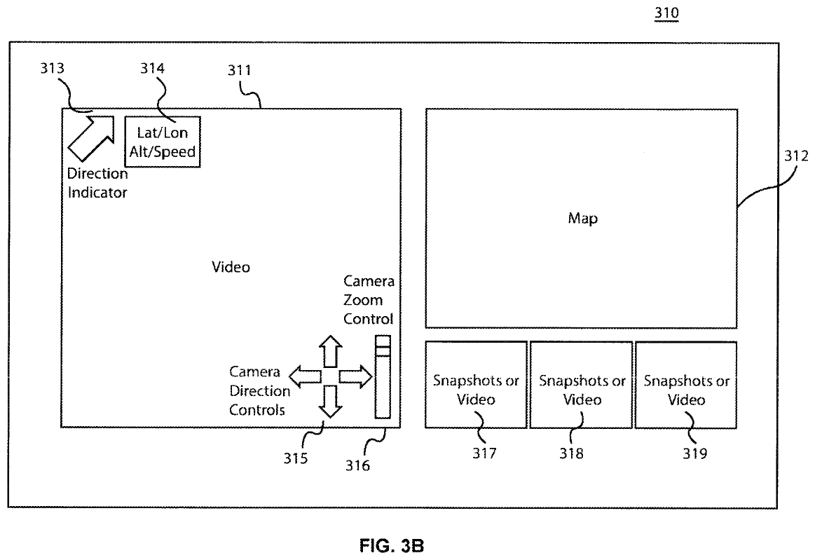

FIG. 3 is a flowchart of a method 300 to provide a remote wildlife viewing according to one embodiment. In one embodiment, the method 300 is performed at a drone apparatus, e.g., a drone 111. In another embodiment, the method 300 is performed at a communication hub, e.g., a communication hub 108. The method 300 begins at an operation 301 that involves receiving an indication from an application server that a user is enabled to log onto the apparatus. At an operation 302 one or more commands to capture wildlife images for the user are received. At an operation 303 wildlife images are captured using one or more of the cameras in response to the one or more commands. At an operation 304 the one or more wildlife images are sent via a communication hub to the application server to display on a user device. In an embodiment, an apparatus for a remote wildlife viewing includes one or more cameras; and a processor coupled to the one or more cameras that is configured to perform method 300. In an embodiment, the apparatus to provide a remote wildlife viewing includes a housing coupled to the processor, a helium balloon coupled to the housing and a mesh surrounding the housing to protect a wildlife. In an embodiment, the apparatus to provide a remote wildlife viewing includes one or more speakers coupled to housing and the processor to create a destructive interference for a sound emanating from the apparatus, a microphone coupled to the processor and a docking port coupled to the processor, as described in further detail below.

In one embodiment, a user keeps track of an animal by digitally tagging the individual animal and digitally marking a location at which the animal is seen. In at least some embodiments, pictures users take are combined with image recognition to maintain counts of species, individual animals, monitor motion of the animals, spot poachers, and perform other research.

In one embodiment, a process of landing drones to recharge is automated or largely automated. In one embodiment, a person at the location of the conservancy maintains the system for many drones. Flashing lights, infrared source, or other radio beacon at a particular frequency are used to precisely steer a drone to a charging station. Magnets and/or physical guiding funnels at the charging stations are used to dock the drone automatically to recharge batteries.

In one embodiment, the users pay for a certain amount of time on the drones at the time of booking, and the revenues are split between the system provider and the wildlife conservancy.

In one embodiment, the remote drone controlling and nature viewing system is used for gaming. Users log onto one or more drones and see how many different species of animals they can spot in their allotted time. In one embodiment, one or more automatic image recognition techniques, e.g., a deep-learning neural network image recognition technique that is used to classify pictures of dogs and cats on the Internet, is used to classify species. In an embodiment, individual animals, e.g., elephants, are identified based on the individual animals unique distinguishing traits using one or more automatic image recognition techniques.

In one embodiment, initially the users review the images to classify whether or not a unique species or individual animal is spotted in each image. The classified image bank is then used as a database to train machine learning image recognition. The user attempts to get a significant number of the animal or plant species images for recognition. The user that spots and sufficiently photographs the greatest number of species wins, e.g., based on a point system. In an embodiment, a user attempts to identify the species that were spotted. In an embodiment, an educational material on the different species of animals, birds, and/or plants is provided to the user to identify the species. The game involving spotting and photographing animals such as birds by drones can be a thrill, for example, for birdwatchers around the world. In one embodiment, the drones flight is limited so that the users cannot chase birds or other animals.

In one embodiment, the drones are covered with protective mesh so no harm comes to animals in the case of collisions. Light protective mesh is currently less than 50 grams and does not significantly affect the flight time of commercially available drones costing approximately $1000.

In one embodiment, the drones are made more quiet so as not to disturb animals or people and/or are geo-fenced to remain at a distance so that certain animals cannot hear them. In one embodiment, the drone noise is reduced by using larger propellers running at a lower frequency than conventional propellers. In another embodiment, the drone noise is reduced using propellers/rotors that run at different frequencies, so that there is not a single high-intensity tone of noise. This can be achieved with one engine of the drone running gears of different ratios; or with multiple engines running at different frequencies. If the engine is the primary noisy component, the use of a single engine at a single frequency at a single point source can make the sound more easy to actively cancel. In one embodiment, the drones are designed to avoid the sound frequency of buzzing bees which is disturbing to certain animals.

In one embodiment, the drones transmit a sound from a speaker that is designed to destructively interfere with the sound being generated by the propellers and/or engine to cancel noise at a wide angular range. This involves the propellers and/or engine running at a slow enough frequency that the distance between the noise-making engine or propeller and the sound-generating speaker is small. In this way, destructive interference can be achieved for animals or people at all angles around the drone. For example, if the noise-making propeller is separated from the speaker by 10 cm, then the sound waves should be roughly 10 times this length or lm, in which case the frequency of the rotors may be no more than 300 m/sec/1 m=300 Hz. In addition, a speaker can be placed to optimally reduce noise in a cone beneath the drone for the organisms that are closest to the drone. Furthermore, a microphone can be used to sense the noise emanating from the drone, or parts of the drone, and emit sound which is designed to be 180 degrees out of phase with the noise to be cancelled.

In one embodiment, a drone includes a directional microphone that enables a user to hear the sound of the animals, such as for example the call of a bird. In one embodiment, signal processing on the digitized audio signal is used to filter out the sound of the drone. This can be based on a template for the drones typical sound in the time or frequency domain, or include a separate microphone that measures the sound being made by the drone in real time.

In one embodiment, a drone includes a microphone and automatic audio recognition capability to identify the sound of a shot being fired. Multiple drones can have this capability. In one embodiment, by all drones being synchronized to a standardized clock, such as GPS, and having their own position, the drones triangulate the location of the shot being fired. This approach uses timing of receipt of the sound multiplied by the speed of sound to range to the location. More specifically, one can determine the difference in the range to the source between 2 receivers to find an angle to the source, and 3 receivers can be used to triangulate the source. One or more drones can then be directed to this position in order to detect possible poaching activity.

In one embodiment, the users report any suspicious activity they see to a central control station in order to prevent illegal activity such as poaching. Users could volunteer to patrol for poachers and conservation staff could have particular notification to illustrate that they are not poachers, such as beans generating a signal at a particular frequency.

### A Platform for Remote Wildlife Viewing According to One Embodiment

In at least some embodiments, the platform enables a drone to be flown and the drone camera to be controlled remotely from anywhere in the world with a robust Internet connection. In at least some embodiment, the platform for remote wildlife viewing is a NatureEye™ platform.

The stages to use the platform for remote wildlife viewing and the platform-automated interactions and functions for each stage may be as follows:

Stage 1: Book a Flight
1. User chooses a conservation location.
2. User chooses a flight time and books a single appointment (e.g., a 25 minute appointment) or bundle that is linked to their on-line calendar (e.g., Google™ calendar, Yahoo™ calendar, Outlook™ calendar, or any other on-line calendar).
3. User is asked to create an account (e.g., a NatureEye™ account) when booking the flight.
4. Credit card payment processing through on-line credit card payment systems, e.g., a PayPal™, GooglePay™ credit card payment, or other on-line credit card payment systems. A gift card option is offered.
5. At the appointed time the user gets an e-mail alert, and clicks on a link in the website (e.g., NatureEye™ website) or in the email to begin the appointment.

Stage 2: Fly a Drone
1. User watches a video (e.g., a 5 minute tutorial) on how to control the drone.
2. User Interface (UI)
   Desktop Option:
      1. A user controls the drone's horizontal movement by using the keyboard arrow keys or WASD keys, controls the drone's vertical movement by pressing SPACE key to go up and pressing SHIFT key to go down, and controls the drone's gimbal by dragging the mouse to where they want to look. In at least some embodiments, when the drone hits a geo-fence, a message with an arrow showing a direction that can no longer be travelled is displayed in, on, or next to the video link. In at least some embodiments, a geo-fence outline is displayed on a display device, as described in further detail below. In at least some embodiments, the geo-fence is checked approximately every few seconds and more frequently as the drone approaches closer to the geo-fence. In at least some embodiments, a map is generated indicating a location of the drone relative to the geo-fenced area on a display device.
   Mobile Option:
      2. A user controls the drone's horizontal move via joystick movement, controls the drone's vertical movement with up and down arrow icons, controls the drone's gimbal by dragging on the screen in the direction of where the user wants to look.
3. Preflight test (to test the controls).
4. To prevent crashes, the drone's collision detection and avoidance systems are automatically enabled, and stay active throughout the whole period of the flight.
5. When time runs out (e.g., after approximately 25 minutes), the user can still see video footage but the drone lands in autopilot.
6. When the drone lands the user is thanked and the video feed ends.

Stage 3: Capture and Share
1. A user has the option to zoom in with the drone's lens at 2× optical or 4× digital.
2. A UI is used to let the user take photos and record videos of the flight.
3. Provide a stream link that can be shared with friends and family, where they can view the streamed flight. In at least some embodiments, sharing is enabled on a social media application (e.g., Facebook™, Whatsapp™, or other social media application).
4. At the end of the flight the user is provided a quick preview of the photos and videos he/she took with the option to download and share them.
5. Offer a donation button for the user to donate to a conservation site. Link button to the conservation location's donation page on their site.

Table 1, provided below, lists actions for building the platform for remote wildlife viewing according to one embodiment.

TABLE 1
Actions for building platform

| # | Action/Task | Comment |
|---|---|---|
| 1 | Booking- | An exemplary location to be |
| | Create a booking system that allows | implemented and geo-fenced |
| | users to use Google ™ calendar | is the garden at 500 |
| | application programming interface | Berkeley, Menlo Park, USA. |
| | (API) for scheduling, reminders and | |
| | accessibility. | |
| 2 | Payment- | |
| | Integrate a payment handling service | |
| | (Stripe ™, Square ™, or other payment | |
| | service) for the purchasing of flights, | |
| | flight bundles, and gift cards. | |
| 3 | UI- | As an example, mouse and |
| | Design a UI, mouse and keyboard for | keyboard are implemented |
| | PC and joystick for mobile. | for PC. The mobile joystick |
| | | uses the existing mobile |
| | | control software. |
| 4 | Flight tutorial video- | |
| | Record a 5 minute video going over | |
| | how to control the drone. | |
| 5 | System architecture- | |
| | Integrate FlytBase ™ APIs into the | |
| | platform. | |
| 6 | System interface- | |
| | Set up a web application that runs the | |
| | platform. | |
| 7 | Feedback- | |
| | Set up a feedback form for the user | |
| | after the flight. | |

### System Modules

In at least some embodiments, a platform for remote wildlife viewing may comprise one or more of the following modules:

1. Booking Module

In at least some embodiments, a booking module comprises a user sign-up module, a user login module, a module representing different conservancies to tour, and a calendar scheduler module. In at least some embodiments, the booking module is implemented using an HTML/JavaScript™ website building software.

1.1. User Sign Up:

In at least some embodiments, a signup page is displayed on the NatureEye™ website, written in an HTML/Javascript™ language.

1.2. User Login:

In at least some embodiments, a user login is implemented using an off-the shelf website package

1.3. Module Representing Different Conservancies to Tour:

In at least some embodiments, a conservancy is represented by a picture, a web link to the location; and a video. Embedded videos are in Moving Picture Experts Group (MPEG) format and played using an off-shelf website package. In at least some embodiments, a paragraph description of the conservancy is displayed on the website (e.g., NatureEye™ website).

1.4. Calendar Scheduler:

A calendar showing a time slot availability is shown on the NatureEye™ website. In at least some embodiments, booking is implemented using an off-shelf website package.

In at least some embodiments, an email is sent to the user with the link to integrate with Google Calendar™.

2. Notification Module:

In at least some embodiments, a notification module is coupled to the calendar scheduler to send a user reminder e-mail. In at least some embodiments, once per day, all bookings that are due the next day are reviewed and reminder e-mails with link to drone feed that becomes active at a specific time is sent to the user.

3. Payment Module:

In at least some embodiments, payment is processed using GooglePlay™ plugin, Square™, or other payment plugins.

4. User Interface (UI):

FIG. 3B is a diagram illustrating a user interface (UI) 310 for a remote wildlife viewing according to one embodiment. As shown in FIG. 3B, the user interface 310 comprises an image portion 311 and a map portion 312. In at least some embodiments, the image portion 311 displays a video associated with the remote wildlife viewing. In at least some embodiments, the image portion 311 displays one or more static images associated with the remote wildlife viewing. In at least some embodiments, the image portion 311 displays both the one or more static images and the video. The image portion 311 comprises a direction indicator 313, a location/speed indicator 314, camera direction controls 315, and camera zoom controls 316, as shown in FIG. 3B. The UI 310 displays icons representing recent snapshots or videos 317, 318, 319. In at least some embodiments, the location/speed indicator 314 indicates at least one of a drone location latitude, a drone location longitude, a drone location altitude or a drone speed.

In at least some embodiments, if a user logs onto the drone feed early, an indicator representing a countdown to start time is displayed on the UI 310. Once a user starts flying, a video is fed from the drone and displayed on the image portion 311. The drone direction, altitude and speed are also shown on the UI 310. In at least some embodiments, the video is derived from a DJI™ application. In at least some embodiments, streaming to the user is enabled. In at least some embodiments, a map indicating a location of the drone relative to a geo-fenced area is displayed on the map portion 312. In at least some embodiments, the map is displayed using HTML/Jscript™.

5. Sharing

In at least some embodiments, upon completion of session, small icons representing all images/videos taken during the flight are displayed. The icons are expandable when clicked. The image/video sharing options are available when clicked. The sharing options include Facebook™, Whatsapp™, text messaging, e-mail, and other sharing options.

6. Flight Control Software

In at least some embodiments, the flight control software is implemented using a Flightbase™ application. In at least some embodiments, the flight control software runs on the application server, cloud, onsite base station, or any combination thereof. In at least some embodiments, JAVA/JAVAScript™ APIs provided by Flightbase™ are accessed to enable the website functionality.

7. On Location Base Station

In at least some embodiments, an on-location base station provides communication with both the drone and the Internet. In at least some embodiments, the base station comprises a DJI™ remote control device attached to a cell phone and/or a laptop. In at least some embodiments, the application on the cell phone/laptop is a DJI™ base station software. The DJI™ remote control connects to the drone via a long-range wireless fidelity (WiFi). In at least some embodiments, a remote control antenna in an outdoor elevated position is coupled to the base station. In at least some embodiments, the cell phone/laptop connect to wifi or ethernet if present on site. Otherwise, the cell phone connects to Internet via 4G. (In at least some embodiments, a StarLink™ is used to provide Wifi with low-latency connection.

Referring back to FIG. 1C, the system for remote wildlife viewing may comprise a plurality of systems as follows:
Client—Javascript™ running in a browser (client);
Application Servers—an application logic that manages the system to provide remote wildlife viewing (application server);
Drone Control System—a system that allows the users to control a drone. This may be a FlytBase™ functionality (drone control system);
Drone Control Bridge—a system for accepting drone commands and controlling the drone (drone control bridge). This may be the FlytBase™ functionality;
Reservation System—a system that allows users to schedule or book a flight (reservation system); and
Authentication Services (authentication services).

### Authentication and Identity Verification

1. Authentication

In an embodiment, an end-user is authenticated using industry standard technologies and practices including OAuth 2.0 and JSON Web Tokens (JWT). There are three primary components involved in the authentication of end-users. The end-users can be authenticated by two different means: username and password authentication, or external identity service.

In an embodiment, a client that is not authenticated is redirected to an authentication service of the system to sign in. A user is presented with the option to sign in with a username and password or with an external identity service (e.g., a Google® or Facebook® account). If the user opts to sign with an external identity service, the user will be redirected to that external identity service using an OAuth 2.0 flow. If the user opts to sign in with a username and password, the user will be validated against a stored username and salted and hashed password. In an embodiment, passwords are salted and hashed with bcrypt and all user data are encrypted at rest with a minimum of 128-bit AES encryption. If the authentication service is able to successfully authenticate an end-user, the authentication service will return a JWT to the client, which will be stored on the client. In an embodiment, the JWT contains the information to identify a user (e.g., a stable unique identifier for that user) and is cryptographically signed by the authentication service.

In an embodiment, when an authenticated client attempts to access protected resources from the application servers, the client includes the JWT with the request. The application servers—when processing a request which requires authentication—ensure that the request contains a JWT. The application servers validate the cryptographic signature of the JWT to ensure that it was authentically generated by the authentication service and was not tampered with. Once the JWT has been validated, the application servers use the unique user identifier.

In an embodiment, if the application server receives a request that requires authentication that does not include a JWT or includes an invalid JWT, the application server rejects the request and returns an error code instead of processing the request.

In an embodiment, as an anti-poaching measure, the authentication service is configured to require 2 Factor Authentication (2FA). This can be configured to require 2FA in different scenarios. Scenarios that 2FA may be needed are on any user sign in to the application; on any user's first sign in from a new IP address or geographic region; just before a user begins any flight in the system; or just before a user begins a flight in specific locations. Each of these scenarios are independently configurable and can be adjusted in response to anti-poaching efforts.

2. Identity Verification

In an embodiment, in the context of drones operating over nature reserves being controlled by external users, identity verification is a component to support anti-poaching efforts. In at least some embodiments, completing an identity verification is needed to access certain components of the application such as making a flight reservation, or starting a flight. When the user makes their first reservation, after choosing a time slot and before payment, the user is asked to perform an identity verification operation. In this operation, the user is requested to submit an image of a government issued identification card (e.g., a passport or driver's license). The user then proceeds to payment. In one embodiment, the system verifies that the identification card is valid, verifies that the identification card is from an allowed country, and stores the identification information for a prescribed period. This allows recourse in case of an adverse event (like poaching).

In an embodiment, the system asks for identification at the time of the user's first flight reservation. Subsequent reservations may not require identification. In an embodiment, the identification feature is configurable on a per location basis. This is because not all locations may have a poaching risk.

### User Profiles

In an embodiment, the application server of the system stores information about a user's past and upcoming flights in a user profile. In an embodiment, the user profile also contains saved media from previous flights, saved payment details, the status of the identity verification, as well as any other information the system needs about a user to operate.

### Roles

In an embodiment, the system for a remote wildlife viewing provides a number of user roles which authorize a user for particular tasks. Example roles are shown in Table 2 below.

TABLE 2
User Roles

| Role: | Description: | Authorizations: |
|---|---|---|
| User | A normal user | Reserve a flight; fly the reserved |
| | (customer of the | flight |
| | system) | |
| Location | Administrator for a | Change the flight parameters for |
| administrator | given location in | any drone in the assigned location |
| | charge of all the | (see Drone Parameters section); |
| | drones for that | View all upcoming reservations |
| | location | for their location; |
| | | Cancel a reservation for a drone |
| | | in their location; |
| | | Refund a reservation for their |
| | | location; |
| | | View media files recorded by |
| | | drones in their location |
| Guide | Guide assigned to a | Join a reserved flight session; |
| | particular location | Take control of a flight which is |
| | | in progress; |
| | | View all upcoming reservations |
| | | for their location; |
| | | Cancel a reservation for a drone |
| | | in their location |
| System | System-wide | Elevate and/or change user roles |
| administrator | administrator | (e.g., from User to Location |
| | | Administrator); |
| | | Prevent users from logging in; |
| | | Force password reset; |
| | | Has location administrator and |
| | | Guide authorized functions for all |
| | | locations |

### Purchases and Flight Reservations System

There may be four primary components to the flight reservation system. In an embodiment, a payment processor is an external system that is exposed with HTTPS requests to process credit cards or other payment mechanisms to charge users. In an embodiment, a drone inventory management system is a system that stores information about which drones are available at which locations. The drone inventory management system can also store the flight reservations for each drone, and can make a list of available times for flight reservations available to other systems. In an embodiment, the list of available times for a drone of location takes into account operational downtime needed by the drone (for example, a small downtime for simple drone turnaround after each flight; a larger downtime for charging for each drone after several flights, or an occasional downtime for an inspection, maintenance, and servicing window).

In an embodiment, application servers are a set of servers that are available to the client over the public Internet that manage authentication and authorization of individual users and facilitate the interaction between the client and the payment processor and the drone inventory management system.

In an embodiment, the client is a set of Javascript™ that runs in the context of the user's browser when a user visits the flight reservation webpage which interacts with the application servers based on the user's choices.

In an embodiment, when the client begins the flight reservation process, the application server checks that the user's account has completed the identity verification process. When an end-user is authenticated, the user first selects a location where they wish to reserve a flight. After the user selects a location the application server retrieves a list of drones available for that location from the drone inventory management system. As discussed above, this list of availability takes into account the operational downtime for the drone. When the user selects a date and time for a flight, the application server requests the drone inventory management system to create a temporary reservation for the selected flight time.

In an embodiment, after creating the temporary reservation for a flight time, the user is presented with a payment screen. If the user has not yet completed identity verification the end-user is requested to complete the identity verification process. The user enters their payment details. If the user enters a credit card payment method their payment details are sent directly to the PCI compliant Payment Processor without passing through the application servers. The payment processor returns a payment token that represents the payment details. The client then sends that payment token to the application servers. The application servers then create a charge by sending the payment processor the payment token and charge amount. If the payment processor is able to successfully create a charge, the application server converts the temporary reservation in the drone inventory management system into a permanent reservation. The application server returns a confirmation code to the client which is displayed on the screen for the end-user. If the user does not complete their purchase within the window of the temporary reservation, the temporary reservation is released.

### Flight Control

System Overview

There may be four primary components of the drone flight control system.

In one embodiment, the drone control bridge is an application running on a piece of hardware which bridges the control of the drone to the Internet. The purpose of the drone control bridge is to translate commands received from the drone control system via the Internet into controls on the drone controller. In one embodiment, the Drone Control Bridge comprises a microcontroller and/or processor that is configured to execute a software running on an Android OS based device that communicates with the drone control system over the Internet. In one embodiment, the Drone Control Bridge comprises a microcontroller and/or processor that is configured to execute a software running on an Android OS based device that communicates to the drone controller over USB. In one embodiment, the drone control bridge registers itself and the identifier for the drone with the drone control system. In one embodiment, the drone controller provides a USB-based API to pass commands and receive telemetry data and video streaming data. The drone control bridge stream telemetry and video data back to the drone control system.

In at least some embodiments, the drone control bridge communicates with the drone controller using drone controller specific APIs over a direct cable, Wifi, Bluethooth™ or other transport protocols. In at least some embodiments, drone controllers run on generic hardware (e.g., Android or iOS based phones) which may allow bridge software to be installed directly on the drone controller. In at least some embodiments, drone controllers provide APIs to the Internet, and can thus be bridged directly to the drone control system without the need for a direct connection to the drone controller.

In an embodiment, the drone control system is an application which provides an interface to external applications to manage sending control commands to specific drones through protocols such as https. In at least some embodiments, the drone control system communicates with the drone control bridge using TCP and UDP based protocols over the Internet. These protocols define both commands sent from the drone control system to the drone control bridge and streaming data including telemetry and video from the drone control bridge back to the drone control system. The drone control system API is described below.

In an embodiment, application servers are the system of servers that are available to the client over the public Internet that manage authentication and authorization of individual users and dispatch authorized commands to the drone control system. The application servers communicate with the drone control system over SSL channels (both HTTPS and secure websockets).

In an embodiment, the client is a set of Javascript™ that runs in the context of the user's browser when they visit the flight control webpage which interacts with the application servers and originates control commands.

Drone Registration

In an embodiment, when a drone and the related drone control bridge is turned on and enabled, the drone controller bridge registers itself with the drone control system, making the drone available to be controlled remotely. In one embodiment, the drone control system updates the drone registry to note that the associated drone is available, and to indicate which drone control bridge needs to be used to send control commands to the drone.

Starting a Flight

In an embodiment, at the beginning of a flight the end-user visits the flight control page. The client makes an authenticated request to the application server that identifies the end-user as well as the flight the end-user wishes to control. The application server validates the request by ensuring that the authentication is valid using the authentication process as defined above. Accordingly, the end-user has identified an existing flight which is scheduled to begin in the near future. If the request is validated, the application servers and client open a reliable and secure duplex communication channel (“message channel”)—e.g., a secure WebSocket connection.

In an embodiment, when the message channel is first opened, the application servers should send a flight status message to the client. In an embodiment, the flight status message contains the state of the flight (e.g., Preflight, Inflight, Postflight, or Error) and other metadata about the current flight (e.g., the current flight duration, the remaining flight time, any notifications that need to be presented to the user).

In an embodiment, the client then makes a separate authenticated request to the application server to obtain a video stream. The application server invokes a set of code on the drone control system that produces a URL to a video stream that is available on the public internet that displays the live feed from the camera of the drone. The client then displays the video in the browser as an underlay below any of the control user interface. In an embodiment, the format of the video stream is MP4 and the quality of the video stream is 720p.

Flight Control

In an embodiment, when the flight is in a state that the client is allowed to control the drone, the client sends the desired state of the drone to the application servers via the drone control command message. The client send a message that contains the setpoint for the aspects of the drone operation that are allowed to be controlled (e.g., the vertical-velocity setpoint, the forward-velocity setpoint, the horizontal-velocity setpoint, and the yaw-angular-velocity setpoint). Each setpoint is expressed as a unitless value from −1 to 1.

The drone control interprets each unitless setpoint, translates it into physical units (e.g., 3 m/s, or 0.2 rad/s), and ensures that the overall setpoints represent a safe overall drone state (certain distance from the ground, within geo-fenced area, etc.). If the overall translated setpoints represent an unsafe state, the application server reduces the setpoints until the overall system represents a safe overall drone state. Finally, the application server system invokes a set of code on the drone control system that applies the translated and safe setpoints to the drone. In an embodiment, the set of code on the drone control system uses the drone registry and the drone control bridge to deliver the commands to the actual drone.

In an embodiment, to ensure the safe operation of the drone, the client sends the drone control command message to the control system on a frequent and regular interval (e.g., 1 message per second). The application server ensures that the drone is actively controlled by the client by ensuring that the drone control command message is regularly received from the client. If a certain duration elapses (e.g., 3 seconds) without receiving a drone control command message from the client, the application server automatically updates the setpoints on the drone to be safe values (such as all 0 velocity setpoints). If drone control command messages start being received from the client again, the application server resumes applying the command messages to the drone. If a longer duration elapses (e.g., 1 minute) without receiving a drone control command message from the client, the application servers automatically invoke a set of code on the drone control system that returns the drone to its home position, and terminates the flight. If drone control command messages start being received at this point the application servers discard the messages, and instructs the client to establish a new connection to resume the flight.

In an embodiment, to ensure the responsive operation of the drone, the client send an extra drone control command message to the application servers whenever the user begins or ends an action. For example, if the end-user presses down a key indicating the drone should have a positive forward velocity setpoint the client should immediately send a drone control command message that includes the updated forward velocity setpoint. When the end-user later releases that key, the client should immediately send a drone control command message that includes a zero forward velocity setpoint. In an embodiment, this control mechanism is applicable to any remotely controlled machine that is capable of streaming video, and is able to be operated by setting velocity setpoints (e.g., a boat, submersible, submarine, quadcopter, etc.).

### Drone Parameters, Geo-fencing and Points of Interest

In an embodiment, each drone references certain parameters. Those parameters may be configurable by the location. Examples of parameters include:
1. Available times and dates. This comprises:
   a. Time ranges per day of week for regular slots
   b. Additional time ranges available for specific dates
   c. Exceptions (e.g. holidays, maintenance windows, guide vacations) that override normal time ranges in (a)
2. Flight time. This indicates the allowed flight time for the drone. In an embodiment, the flight time is less than the anticipated battery life by a predetermined safety margin. Reservations are offered for this duration.
3. Points of interest. This is a set of points (e.g., GPS coordinates) and associated description text of each point. These points are shown to the user as points of interest which are available on flights for that particular drone. Optionally, each point of interest includes a URL which can provide rich detail and media describing each point.
4. Geo-fencing volume. This parameter describes a volume of space outside which a drone is not allowed. The volume is described as a set of three dimensional GPS coordinate vertices connected in a graph. The drone control system does not allow the drone outside that predefined volume during flight. If the user attempts to fly outside this volume, the drone controller returns an error code which is displayed to the user and the drone stops at the boundary. Since the geo-fencing is described as a three dimensional volume, it can be used to keep the drone roughly along a particular path, prevent the drone from hitting obstacles, and/or can be used to prevent the drone from flying too low and disturb wildlife. Also, because it is a configurable three-dimensional volume, the minimum heights can be adjusted to accommodate variable topography.
5. Media capabilities. Different drones may have different media recording capabilities. For example, some drones may provide 4k video while others may provide 1080p or less. This field provides the system with media capability per drone so users know ahead of time what to expect.

### Drone Control Rest API

The following comprises an example functionality of a the Drone Control Rest API, including, in some places, a representative code.

Get Flight Operation Information

GET/api/v1/flight/:id/ops

Get flight operation status, including the video stream URL.

Response

TABLE 3
Response Codes

| Code | Reason |
|---|---|
| 200 | Flight Operation is available |
| 404 | No Flight matching the given ID was available to the user |
| 422 | The Flight was found, but is not yet ready to begin |
| 503 | The Flight was found, and should be ready to start, but the |
| | drone was not available |

```
interface Flight Operation
  Response {status: FlightStatus;
  streamUrl: string;
}
```

Start Flight Operation Control

WEBSOCKET-GET/ws/v1/flight/:id/ops

Begin a flight control session. In an embodiment, this is called once the front-end has finished loading, is displaying and running the video stream, and is ready to being control of the drone. In an embodiment, this is a websocket connection. This should be a websocket connection.

Drone Control Websocket Operation API

In an embodiment, every message sent over the websocket connection is a single serialized JSON object. Each JSON object have a messages types are defined below.
Client→Server
Drone Control
Type: drone-control
Direction: Client→Server
This message carries the client's desired setpoints for the drone at any given moment. Upon receipt of this message, the server applies the given setpoints to the drone, if any changes are present from the last update. This message may be sent on a 1 second heartbeat, and immediately whenever the user makes a control change.

interface DroneControlMessage {
type: “drone-control”;
drone: {
x: Velocity;
y: Velocity;
z: Velocity;
yaw: Velocity;
};
camera: {
pitch: Velocity;
yaw: Velocity;
zoom: number; // 0 to 1
};
}
type Velocity = number; // range from −1 to 1

Request Flight Status Message
Type: request-flight-status
Direction: Client→Server
This message requests that the server send an updated flight status message. Upon receipt of this message, the server sends back a flight-status message.

interface RequestFlightStatusMessage {
type: ‘request-flight-status’
}

Request Photo
Type: take-photo
Direction: Client→Server
This message requests that the server takes a photo from the drone.

interface TakePhotoMessage {
type: ‘take-photo’
}

Start Video Message
Type: start-video
Direction: Client→Server
This message requests that the server start recording video from the drone.

interface StartVideoMessage {
type: ‘start-video’
}

Stop Video Message
Type: stop-video
Direction: Client→Server
This message requests that the server stop recording video from the drone.

interface StopVideoMessage {
type: ‘stop-video’
}

Server→Client
Flight Status
Type: flight-status
Direction: Server→Client

This message carries the full flight status for a given flight. This should contain everything the client needs to know about the current flight. This message should be sent at the start of a given flight, on a 1 minute heartbeat, and in response to a request-flight-status message.

```
  interface FlightStatusMessage {
  type: “flight-status”;
  status: FlightStatus;
}
  type FlightStatus = PreflightStatus | InflightStatus | PostFlightStatus |
  FlightErrorStatus;
  interface PreflightStatus {
  state: “preflight”;
  timeToTakeoff: Duration;
  flightTimeRemaining: Duration;
  flightTimeReserved: Duration;
  }
  interface InflightStatus {
  state: “inflight”;
  inControl: boolean;
  pilotid: string;
  flightTimeRemaining: Duration;
  flightTimeReserved: Duration;
  photosTaken: number;
  photos Allowed: number;
  recording: boolean;
  videosTaken: number;
  videoTime: Duration;
  videoTime Allowed: Duration;
  notifications: Notification[ ];
  }
  interface PostFlightStatus {
  state: “postflight”;
  actualFlightTime: string;
  reservedFlightTime: string;
  photosTaken: number;
  videosTaken: number;
  videoTime: Duration;
  notifications: Notification[ ];
  }
  interface FlightErrorStatus {
  state: “flighterror”;
  notification: Notification;
  }
  interface Notification {
  level: “warn” | “info” | “error”;
  text: string;
  code: string;
  }
  type Duration = number; // (number of milliseconds) string; // ISO 8601
  Duration String
```

Partial Flight Status
Type: partical-flight-status
Direction: Server→Client
This message carries a partial update to the flight status.

interface PartialFlightStatusMessage {
type: “partial-flight-status”;
status: Partial<FlightStatus>;
}

Bidirectional Messages
Type: ping
Direction: Bidirectional
This message indicates that the receiver should respond with a pong message.

interface PingMessage {
type: “ping”;
}

Pong
Type: pong
Direction: Bidirectional
This message should be sent in response to a ping message. This can be useful for an approximate RTT estimation.

interface PongMessage {
type: “pong”;
}

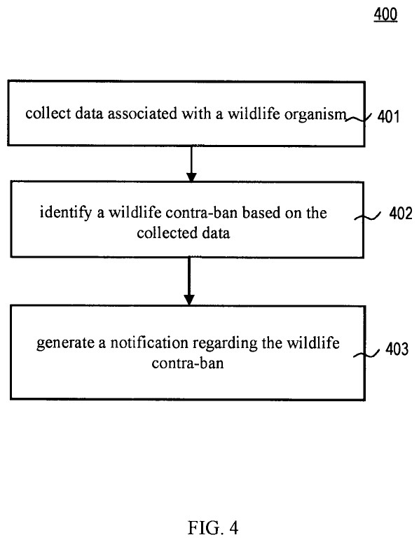

FIG. 4 is a flowchart of a method 400 to detect a wildlife contra-ban according to one embodiment. The method 400 begins with an operation 401 that involves collecting data associated with a wildlife organism 401. At an operation 402 a wildlife contra-ban is identified based on the collected data. In one embodiment, molecules of a wildlife product are detected using one or more sensors. The wildlife contra-ban is identified based on the detected molecules. In one embodiment, the collected data are online sales data, and the wildlife contra-ban is identified based on the online sales data. At an operation 403 a notification regarding the wildlife contra-ban is generated, as described in further detail below.

In one embodiment, the one or more sensors are wildlife contra-ban sniffers. In one embodiment, the one or more sensors are configured to detect molecules of wildlife products, e.g., rhino horn, ivory, tiger bones and/or other wildlife. In one embodiment, the wildlife contra-ban sniffer is about 1000× more sensitive than a sniffer dog. In one embodiment, the conductivity of the molecular wildlife sniffer sensor changes uniquely based on a molecular composition of the wildlife product (e.g. ivory, rhino horns, tiger bones). In one embodiment, the sniffer sensors that may be used at ports for drugs and explosives are modified to sense molecular wildlife contra-ban. In one embodiment, a taste and scent sensor that has the human olfactory and taste receptors put onto a disposable biochip, with a digital readout, as manufactured e.g., by Aromyx Corporation™ located in Palo Alto, Calif., USA is modified to detect wildlife contra-ban. In one embodiment, the one or more wildlife contra-ban sniffer sensors are plugged into a smartphone.

### Feeding Law Enforcement IP Addresses for Illegal URLs on Surface Web

In at least some embodiments, leads related to wildlife contra-ban activities are collected, and fed to law enforcement. In at least some embodiments, a whistleblower fee for all leads that result in fines or arrests is collected. In an embodiment, collecting the leads include executing algorithms that analyze sales online on websites such as E-Bay and Amazon, and that identify which of those sales are likely illegal sales of wildlife products. The algorithm then refers those URLs that are hosting the sale item to law enforcement.

Much of the reason why contra-ban traffic continues on the surface web is the difficulty of sifting through and identifying contra-ban listings. For surface web sites, data can be automatically downloaded and analyzed with machine learning. One study, Hernandez-Castro et al., PeerJ Computer Science. 2015 Jul. 29; 1(4):e10 (DOI:10.7717/peerj-cs.10), which is herein incorporated by reference in its entirety, used a machine learning online contra-ban identification system, implemented by two professors from Leeds University, and demonstrated the automatic detection, by mining sale item metadata, of illegal sales of ivory on UK E-bay with 93% accuracy.

In one embodiment, the system involves a contra-ban database that can be searched by law enforcement or an ongoing data feed mechanism, possibly as simple as e-mail, to send the web location/IPAddress of URLS selling wildlife contra-ban to law enforcement. These could be law enforcement offices that are financially incentivized to achieve more arrests or collect more fines. In one embodiment, the system facilitates the collection of whistleblower fees paid by law-enforcement. One example of one such relevant office in the US is the following:
US Fish & Wildlife Service Office of Law Enforcement
5275 Leesburg Pike, MS: OLE
Falls Church, Va. 22041
Cell: 703-819-2875
Work: 703-358-2520.

### Websites Selling Wildlife Contra-ban on the Dark Web to Catch Buyers

In 2016, most wildlife contra-ban was being traded on the surface web and relatively little on the dark web, as shown by a study in Conservation Biology. See, Harrison et al., Consery Biol. 2016 August; 30(4):900-4 (doi: 10.1111/cobi.12707), which is herein incorporated by reference in its entirety. However, with a growing marketplace of password protected dark web sites, largely fueled by drugs and other contra-ban, more trade will occur on the dark web over time. An approach to diffuse the dark web channel is to set up multiple dark websites selling wildlife contra-ban that feed information to law enforcement. Most dark web commerce sites are sparse and simple. Using, for example, fake rhino horns, see, e.g., LaCapria, Snopes. “Have 3D Printed Rhino Horns Been Developed to Stop Poaching?” 2016 Jul. 11 (available at https://www.snopes.com/3d-printed-rhino-horn-developed/), which is herein incorporated by reference in its entirety, sales can be arranged with under-cover police officers, or where relevant, delivery addresses can be sent to law enforcement for search warrants.

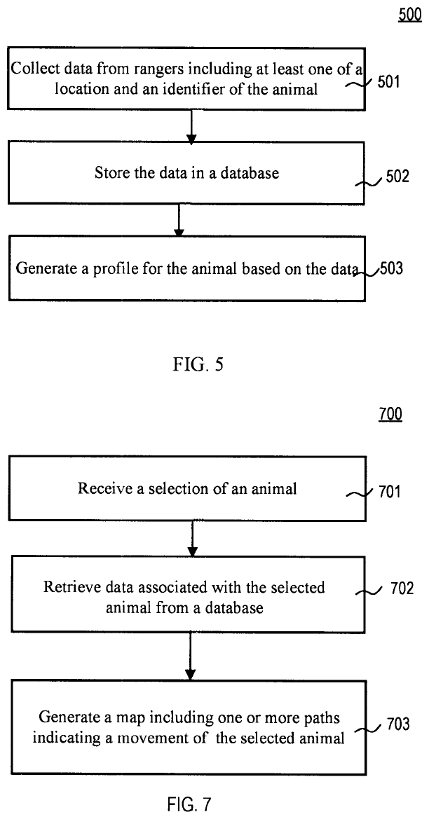

FIG. 5 is a flowchart of a method 500 to monitor individual animals in a conservation area according to one embodiment. The method 500 begins with an operation 501 that involves collecting data associated with the animals from rangers. In one embodiment, the data comprise a location of the animal, an identifier of the animal, or both the identifier and the location of the animal. At an operation 502 the collected data are stored in a database. At an operation 503 a profile for the animal is generated based on the collected data, as described in further detail below.

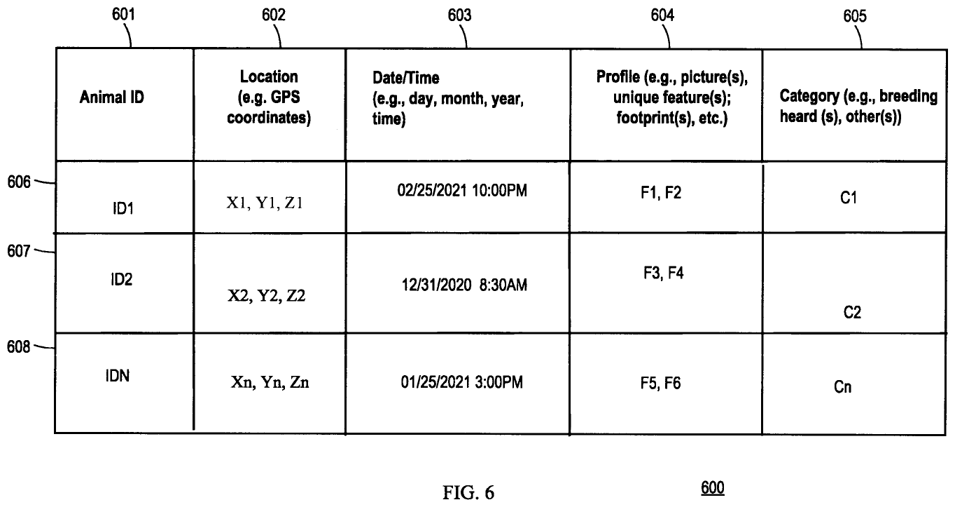

FIG. 6 is an example of a data structure 600 that includes the data associated with animals collected from the rangers according to one embodiment. As shown in FIG. 6, the data structure 600 is represented by a table. In one embodiment, the data structure is created and stored in a storage device, e.g., a storage device 117, or other storage device. As shown in FIG. 6, the table includes an animal identifier (ID) column 601 that includes an identifier (e.g., ID1, ID2, ID3, etc.) that uniquely identifies an animal. The table includes an animal location column 602 showing coordinates X1, Y1, Z1, X2, Y2, Z2, . . . Xn, Yn, Zn (e.g., GPS coordinates, or other coordinates) for the animals. The table includes a date/time column 603 indicating the date and/or time (e.g., 02/25/2021 10:00 PM, 12/31/20 8:30 AM; 01/25/21 3:00 PM) the animal was observed. The table includes an animal profile column 604 that contains animal picture(s), unique animal features (e.g., F1, F2, F3, F4, F5, F6 which may relate, for example to the animal's face, tusks, body and tail), footprint(s), and the like. The table includes an animal category column 605 that indicates animal categories C1, C2, Cn (e.g., breeding herd(s), or other animal category. The table includes one or more rows (e.g., a row 606, a row 607, a row 608). Each of the rows includes an animal identifier and a location, a date/time, a profile and a category that corresponds to that animal identifier.

FIG. 7 is a flowchart of a method 700 to monitor individual animals in a conservation area according to one embodiment. At an operation 701 a selection of an animal is received. In an embodiment, one or more animal IDs are determined based on the selection. In one embodiment, a captured wildlife image of the animal is compared with a stored wildlife image of the animal using an image recognition technique to identify the animal. At an operation 702, the data associated with the selected animal are retrieved from a database based on the animal ID. In an embodiment, the data (e.g., a location, date/time, profile, category, or any combination thereof) that correspond to the selected animal ID are retrieved from the database. In one embodiment, a selection of at least one of an area and a data range associated with the selected animal is received. At an operation 703 a map including one or more paths indicating a movement of the selected animal in the selected area and the data range is generated based on the retrieved data. In one embodiment, a notification is generated and sent to a user when the animal is moved outside of the area.

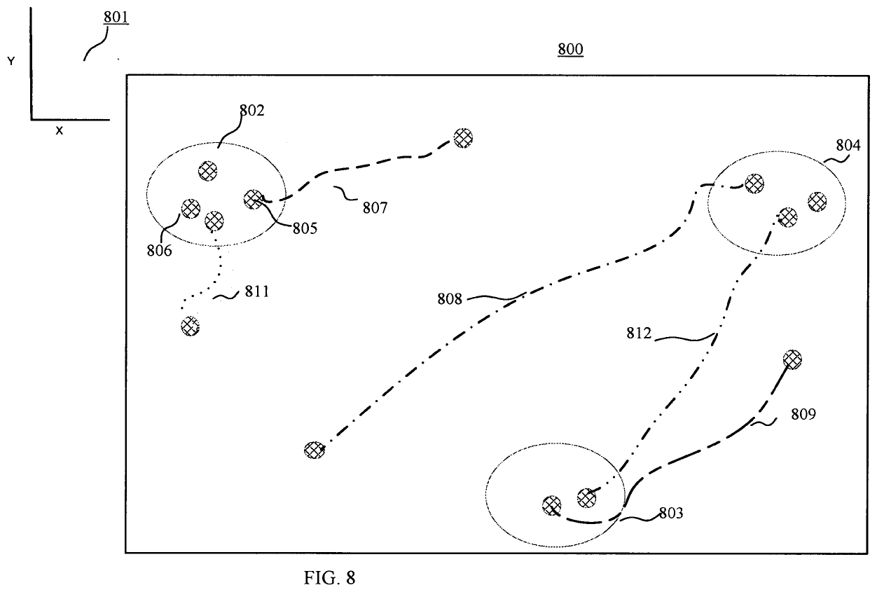

FIG. 8 is a diagram illustrating a map 800 indicating a movement of animals according to one embodiment. The map 800 indicates locations of the animals in location coordinates (e.g., x-y coordinates) 801. As shown in FIG. 8, the animals are sorted into herds, e.g., a herd 802, a herd 803 and a herd 804. The map 800 includes a path 807, a path 808, a path 809, a path 811 and a path 812 indicating a movement of the animals (e.g., an animal 805 and an animal 806) in an area, as described in further detail below.

For example, the system to monitor individual animals in a conservation area can be used for a nature conservation organization, e.g., the Elephant Human Relations Aid (EHRA) in Namibia, or other nature conservation organization. The system may be used to reliably determine how many unique animals (e.g. Dessert African Elephants, or other unique animals) are in an area and what are the migratory paths of the individual animals and herds overlaid on a map, such as Google Maps™. In one embodiment, the system uses GPS-tagged data and photos collected by rangers and volunteers. In another embodiment, the system incorporates image recognition to automate animal identification. For example, in the case of elephants, unique identifying features may include tusks, ears, face, tail and footprints.

Generally, EHRA operates in the region roughly 0-100 km north of the Ugub River and 0-100 km East of the ocean, in Namibia. The goal of the nature conservation organization is to protect the unique animals, e.g., Desert African Elephants, which is a unique subspecies of elephant adapted to the desert environment, and to enable them to continue to roam free in the area. To achieve this goal, EHRA seeks to protect the homes and economic interests of farmers and communities in the area so that they do not hunt the elephants. Reports are generated for the Namibian Government and conservation organizations to record the number of elephants remaining in the area. Although recent government reports claimed that the number of elephants are several hundred, the number remaining is currently roughly 30. One of the reasons for the overestimate is that multiple conservancies around the area submit the number of elephants they have observed and the results is summed. However, the same elephants are counted multiple times as they roam from one area to another. It is possible with ongoing conservation efforts, that elephant numbers can grow again while they continue to roam free in the region.

The system to monitor individual animals in a conservation area can be used to provide one or more of the following functions:
1. Enable accurate estimates of the number of unique animals in conservation areas;
2. Generate a report showing the patterns of movement of one or more animals; and
3. Enable tracking of wildlife by rangers in many areas.
   The system may be accessible online on the nature conservation organization website (e.g., EHRA website).

### Specifications 1

In one embodiment, data is generated by rangers working for a conservation organization (e.g., EHRA) who record the GPS location of each elephant, or other animal siting. The rangers may have learned to identify the unique markings of each animal (e.g., elephant, or other animal) and can include the animal's unique ID together with the location information.

In one embodiment, data from the rangers over roughly ten years are recorded in XLS spreadsheets. These XLS spreadsheets can be imported into the database.

In one embodiment, new data recorded by rangers and volunteers are stored as GPS waypoints in the GPX format. In one embodiment, the waypoint description includes an animal ID. When an animal ID is not available, the data can be stored in an unclassified bucket. In one embodiment, the waypoint is also associated with a picture.

In one embodiment, the database is queried, via a web interface, by selecting one or more animals, a region, and a date range. In one embodiment, the animals are arranged into breeding herds, so that a whole breeding herd can also be selected. A map 800 can be generated that shows a series of different colored lines showing where each of the animals has moved over the designated time frame. In one embodiment, a color legend is generated to indicate the ID of an individual animal 805 represented by a line (e.g., a path 807) on the map. In one embodiment, map 800 is generated on a Google Map™ a Yahoo™ map, or other map.

In one embodiment, a profile is created for each animal including a set of pictures that describe unique features of the animal, e.g., the animal's face, tusks, body and tail. In one embodiment, pictures of the animal's footprints are also included into the profile. In one embodiment, the profile also includes all sightings of the animal associated with that animal ID. In one embodiment, each colored line indicating a path of the animal (e.g., a path 807) on the map is clickable to show the profile of that animal.

In one embodiment, the animals are sorted into breeding herds, which could be single lone animals or groups of animals. In one embodiment, this clustering of animals is created and editable by a user with edit privileges. In one embodiment, lines drawn on the map are categorized into breeding herds, with each herd represented by a different line style: e.g., solid, dashed, dash dotted, dotted, or other style. By clicking on the line style notation in the legend, a user is taken to the breeding herd with all animals in that herd listed. Every animals profile includes a link to the breeding herd for that animal.

In one embodiment, a separate set of dots are recorded on the map for an animal siting where no ID is available. These dots are clickable so that the information can be edited, for example, to add an animal ID.

In one embodiment, the database is queried from a tab on the nature conservation organization website that can be implemented on a content management system, e.g., Joomla™, or other content management system. In one embodiment, the nature conservation organization website is EHRA which is implemented on Joomla™. This requires a password access to prevent unauthorized access by poachers.

In one embodiment, the database is editable by hand, including all information associated with a particular animal such as adding or removing pictures, changing the data associated with each siting, groupings of animals into breeding herds, and changing the animal ID associated with a particular siting, via a web interface for the users with edit rights. In one embodiment, the database is stored every 2-6 months so that old versions can be retrieved.

### Specifications 2

In one embodiment, a map 800 is editable to include particular positions of significance, such as water holes, wells and particular farms. In one embodiment, regions on the map that can be designated for particular characteristics, such as vegetation are drawn on the map. In one embodiment, the breeding herds are automatically generated by a clustering algorithm looking at the proximity of groups of individual animal lines to one another.

In one embodiment, photographs taken of animals are automatically compared to pictures in the animal's profile using an image recognition machine learning technique. Rangers are asked, where possible, to take pictures of the animals when they record a sighting. These pictures are used to verify that the animal ID provided by the ranger is correct. The image recognition can be tested using a database, such as a database from Elephants Alive™ that includes pictures of about 1,500 animals, each with a unique ID. In one embodiment, the image recognition works with different lighting (shadow/sun), different setting (dark/bright), different angles of the animal's ear, etc. In one embodiment, the image recognition is resettable/retrainable for any animal as markings on the animal change. Image recognition functions can include precise designation of the type of images taken (e.g., face upfront, or ear from the side).

In one embodiment, the system provides a notification (e.g., a flag), based on automatic animal ID or data entered in the database, when an animal is seen far outside of the expected pattern of movement for that animal.

In one embodiment, a phone app is available for volunteers, such as from the conservancies in the area, to take photographs of animals and record sightings which can be submitted to the database.

FIG. 9 is a flowchart of a method 900 to monitor a conservation area border according to one embodiment. At an operation 901 a conservation area border is scanned to capture images using the one or more sensors. In one embodiment, the conservation area border is scanned using a satellite telescope border protection mechanism coupled to the one or more sensors. In one embodiment, the one or more sensors include one or more a LiDAR sensor, a radar sensor, an ultrasonic sensor, a global positioning system (GPS) sensor, other sensor, or any combination thereof. At an operation 902 an illegal border crossing is identified from the images. At an operation 903 a notification regarding the illegal border crossing is generated, as described in further detail below.

### Passive Sensing

In one embodiment, a system to monitor a conservation area border includes a border protection mechanism that comprises one or more cameras coupled to a satellite telescope to detect people illegally crossing an area border. In one embodiment, the camera is an infrared (IR) camera having a resolution of 10 cm per pixel to identify a person in an IR image. In one embodiment, the cameras are radiation-hardy IR cameras. The camera-telescope system takes a picture of around 100MP that covers about 1 square km for human detection. That resolution is available though not radiation-hardened e.g. Canon DSLR Camera. 100MP would cover about 1 square km for human detection. The Kruger Park Nature Reserve in South Africa, for example, has a border of about 300 km with Mozambique. In one embodiment, taking a picture every 0.2 seconds covers every section of the border with a picture each minute. Passive IR visuals may not be able to easily see through clouds.

### Active Sensing

In another embodiment, an active sensing system to monitor a conservation area border comprises one or more LiDAR sensors. The active sensing system uses a higher power payload than the passive sensing. Typically, a LiDAR sensor illuminates a target with scattered laser beams and measures distance by time of return. A narrow beam maps physical features with high resolutions. In one embodiment, the one or more LiDAR sensors are used to capture at 3,000 meters in a single pass instant snapshots of approximately 600-meter squares of an area at resolutions of 30 cm or better. In one embodiment, frequencies are chosen to penetrate clouds. A LiDAR sensor can also penetrate foliage (e.g., a Lidar Data Filtering and Forest Studies (TIFFS) software detects non-vegetation data such as buildings, electric power lines, flying birds, etc.) In one embodiment, a system to monitor a conservation area border includes a laser and a telescopic detection system coupled to the laser that is trained on the areas of the border crossings.

### Active Noise Cancellation

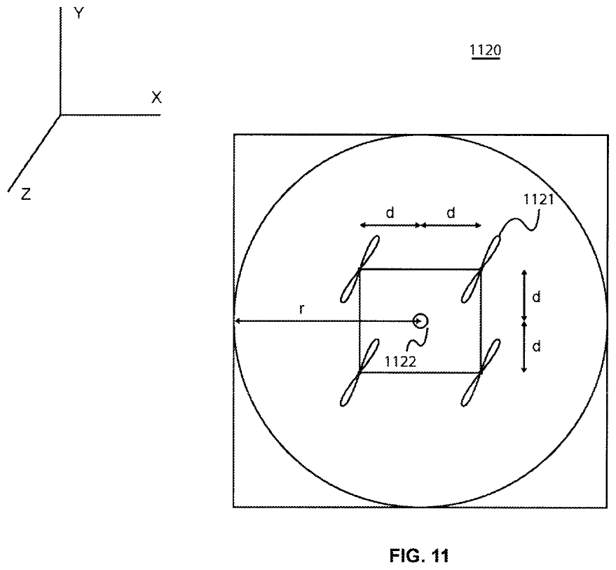

FIG. 11 illustrates a drone setup 1120 for simulation of active noise cancellation to determine speaker amplitude and phase according to one embodiment. A method for active noise cancellation to make drones quieter is described. In one embodiment, the method for active noise cancellation uses a dominant mode or frequency of the drone's noise, although one of ordinary skill in the art may extend the method to address harmonics of the dominant mode as well. The method involves replicating the sound signal that is produced by each of the drone engines or rotors. The four propellers, such as a propeller 1121 are positioned 2d apart on the corners of a square. The method seeks to minimize the average noise amplitude on the sphere of radius r—only the 2 dimensional circular outline of this sphere is shown in the FIG. 11 on the x-y plane. The cartesian x, y and z coordinates are shown in top left of the FIG. 11.

In one embodiment, four speakers are placed at the location of each of the rotors. In another embodiment, a single speaker is placed close to the location of the four rotors, such as at the center of the square, indicated by a small circle 1122. As shown by the simulation below, the active noise cancelling technique works when the speaker is closely collocated with the rotors relative to the wavelength λ of the sound, that is, when λ>>d.

In one embodiment, each speaker is collocated with a microphone which records and digitizes the audio signal. The signal is then phase-adjusted to be 180 degrees out of phase with the incident signal, or to create the inverse of the incident signal, and broadcast out of the speaker at an adjusted amplitude. The phase adjustment of the audio signal to be broadcast would need to account for any processing delay from the incidence of the sound on the microphone, to the digitization of the sound, processing of the signal, and output of the inverted sound signal from the speaker.

In another embodiment, the signal that is produced by each of the engines/rotors at a particular frequency is known a-priori, and the speaker or speakers output a cancellation signal that is pre-determined based on the frequency and pitch or angle of the rotors.

In order to illustrate the concept and reduce it to practice by simulation, the method assumes that the speaker is located in the center of the square, and that each rotor outputs a single tone, or that the dominant tone is address and no the 2nd, 3rd or higher harmonic. The MATLAB™ code below illustrates how effectively cancel the noise of the rotors by finding the optimal amplitude and phase of the tone output by the central speaker. The code first computes the amplitude and phase of the signal to minimize the mean of the noise amplitude on the sphere of radius r. The code then compares the amplitude of the noise generated on the x-y plane over the square of side length 2r with and without the optimal cancelling signal. The code then compares the amplitude of the noise generated on the x-z plane over a square of side length 2r with and without the optimal cancelling signal.

Consider each of the rotors 1-4 to be located at positions indicated by 3 dimensional vectors r_1,r_2,r_3,r_4. If speed of sound is c and frequency of the rotors is f, the wavelength of the sound can be found as λ=c/f. It will be clear to one skilled in the art after reading this disclosure how the method can be adjusted by determining the speed of sound c at each location by considering air pressure and humidity, as well as possible measuring c empirically by sending a signal from a speaker and measuring time of signal receipt at a microphone driven by synchronized clocks. Let the scalar wave number of the signal of wavelength λ be k=2π/λ. Assume all rotors are in [symbol] e [symbol] \hat{ }ik|r-r_1| angular phase with one another and have amplitude normalized to 1. At some point on the sphere r the sounds signal emanating from all of the rotors using complex number notation can be described as follows:

Z(r,t)=e^{i(k|r-r}^{₁}^{|-ωt)}+e^{i(k|r-r}^{₂}^{|-ωt)}+e^{i(k|r-r}^{₃}^{|-ωt)}+e^{i(k|r-r}^{₄}^{|-ωt)} (1)

The amplitude of the sound can then be found as

|Z(r,t)|=|e^{ik|r-r}^{₁}^{|}+e^{ik|r-r}^{₂}^{|}+e^{ik|r-r}^{₃}^{|}+e^{ik|r-r}^{₄}^{|}| (2)

The method now describes a cancellation signal, of amplitude A and phase ρ which is assumed to emanate from the speaker in the center of the square which is at the origin of the coordinate system

Z₀(r,t)=Ae^{i(k|r|+ρ-ωt)} (3)

Then, the compensated signal can be described as

Z_{c}(r,t)=e^{i(k|r-r}^{₁}^{|-ωt)}+e^{i(k|r-r}^{₂}^{|-ωt)}+e^{i(k|r-r}^{₃}^{|-ωt)}+e^{i(k|r-r}^{₄}^{|-ωt)}+Ae^{i(k|r|+ρ-ωt)} (4)

and the amplitude of the combined signal can be described as

|Z_{c}(r,t)|=|e^{ik|r-r}^{₁}^{|}+e^{ik|r-r}^{₂}^{|}+e^{ik|r-r}^{₃}^{|}+e^{ik|r-r}^{₄}^{|}+Ae^{i(k|r|+ρ)}| (5)

ρThis equation forms the basis of the MATLAB™ simulation below where the method minimizes the average amplitude of the signal on the sphere of radius R by choosing the optimal amplitude A and phase. Note that one could similarly optimize for the total noise power over the sphere by considering instead

ρ

|Z(r,t)|²=|e^{ik|r-r}^{₁}^{|}+e^{ik|r-r}^{₂}^{|}+e^{ik|r-r}^{₃}^{|}+e^{ik|r-r}^{₄}^{|}+Ae^{i(k|r|+ρ)}|² (6)

By way of example, if the drone's rotors are rotating at a speed of about 6,000 rpm and the rotors are separated by about 0.3 meters, then to minimize the average amplitude on a sphere of radius of about 10 m, using the MATLAB™ code below, the method finds A=3.71 which is close to 4, to cancel the cumulative effect of 4 rotors when the wavelength λ<<d. The method also finds that ρ=3.14 which is close to π, for an inversion of the signal.

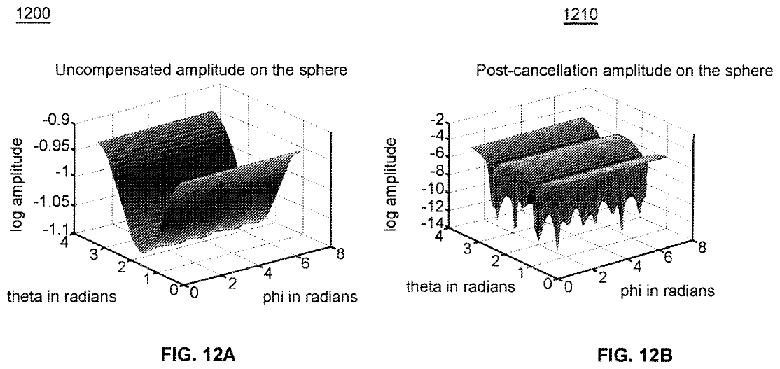

FIG. 12A shows a mesh plot amplitude of a signal on a surface of the sphere, as a function of spherical coordinate angles phi and theta, without a compensation signal 1200 according to one embodiment. FIG. 12A is a mesh plot of log|Z(r,t)| on sphere. FIG. 12B shows a mesh plot amplitude of the signal on the surface of the sphere, as a function of spherical coordinate angles phi and theta, with an approximately optimal compensation signal of A=3.71 and ρ=3.14 (1210) according to one embodiment. FIG. 12B is a mesh plot of log|Z_{c}(r,t)| on sphere. For the parameters in this example, the mean amplitude on the sphere surface was reduced from 0.3712 to 0.0187, a reduction of 20*log10(0.3712/0.0187)=25.96 dB.

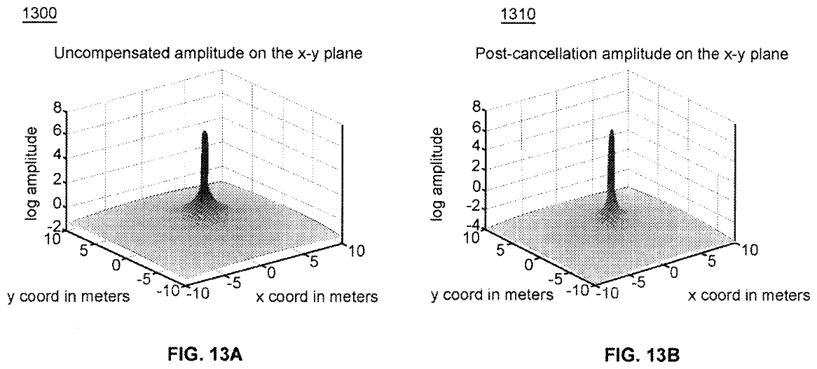

FIG. 13A and FIG. 13B show mesh plots of sound amplitude on the x-y plane, over the square of side length 20 m centered at the origin, respectively without (1300) and with the approximately optimal compensation signal (1310) according to one embodiment. For the parameters in this example, the mean amplitude on the square surface was reduced by 13.31 dB. FIG. 13A is a mesh plot of log|Z(r,t)| on x-y plane. FIG. 13B is a mesh plot of log|Z_{c}(r,t)| on x-y plane.

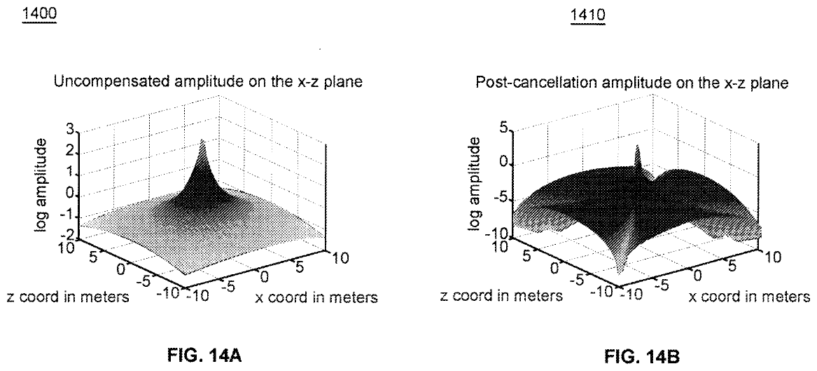

FIG. 14A and FIG. 14B show mesh plots of sound amplitude on the x-z plane, over the square of side length 20 m centered at the origin, respectively without (1400) and with the approximately optimal compensation signal (1410) according to one embodiment. FIG. 14A is a mesh plot of log|Z(r,t)| on x-z plane. FIG. 14B is a mesh plot of log|Z_{c}(r, t)| on x-z plane. For the parameters in this example, the mean amplitude on the square surface was reduced by 24.42 dB.

After reading this disclosure, it would be clear to one of ordinary skill in the art how the method could be adjusted when different rotors are at different pitches, producing different amplitudes of sound. It would also be clear, after reading this disclosure, how the method could be adjusted for rotors moving at different speeds. In one embodiment, the speaker are configured to output separate tones, or separate multi-tone signals to address 2^{nd}, 3^{rd} and higher harmonics of each dominant tone, to cancel the signal coming from each of the rotors at a different angular frequency. In one embodiment, rather than have many different signals at different frequencies output by the speaker, the control law for the rotors can be designed so that at some steady state of flight, the rotors all rotate at the same frequency. In this case, the motion of the drone can be controlled by the pitch or angle and uniform frequency changes of the rotors, but not by different frequencies among the rotors. In general, it may be better to have the drones rotate as slowly as possible, and have the speaker as closer to each noise source as possible. Many variations of the active noise cancelling approach for drones are possible, without changing the essential concepts described herein.

### An Example of MATLAB™ Code for Simulation

```
% drone.m
% rpm=6000; https://dronerush.com/drone-propellers-how-to-fly-science-10010/
% parameters
clear;
delta = .15; % half the separation between adjacent rotors
% position of rotors 1,2,3,4
r1 = [−1 1 0]*delta;
r2 = [1 1 0]*delta;
r3 = [1 −1 0]*delta;
r4 = [−1 −1 0]*delta;
amp_range = [3.5 4];
pha_range = [pi−.01 pi+0.01];
ra = 10; % radius of sphere over which to optimize amp
% ranges over which to explore signal amplitude
x_range = ra;
y_range = ra;
z_range = ra;
% number of simulation points
x_len = 200;
y_len = 200;
z_len = 200;
th_len = 50;
ph_len = 50;
amp_len = 100;
pha_len =100;
% position and angular vectors for simulation
x_vec = [-x_range:2*x_range/(x_len-1):x_range];
y_vec = [-y_range:2*y_range/(y_len-1):y_range];
z_vec = [-z_range:2*z_range/(z_len-1):z_range];
th_vec = [0:pi/(th_len-1):pi];
ph_vec = [0:2*pi/(ph_len-1):2*pi];
amp_vec = [amp_range(1):(amp_range(2)-amp_range(1))/(amp_len-
1):amp_range(2)];
pha_vec = [pha_range(1):(pha_range(2)-pha_range(1))/(pha_len-1):pha_range(2)];
% wavelength comp
c = 343; % speed of sound m/s
rpm = 6000*2;
f = rpm/60; % frequency in Hertz
l = c/f % wavelength
% minimize over sphere
Z_sph_abs_mean_min = inf;
for phacnt = 1:pha_len
  pha = pha_vec(phacnt)
  for ampcnt = 1:amp_len
    amp = amp_vec(ampcnt);
    for thcnt = 1:th_len
      th = th_vec(thcnt);
      for phcnt = 1:ph_len
        ph = ph_vec(phcnt);
        r = ra*[cos(ph)*sin(th) sin(ph)*sin(th) cos(th)];
        rr0 = norm(r,2);
        Z0 = amp/rr0*exp(i*(2*pi*rr0/l+pha));
        rr1 = norm(r-r1,2);
        Z1 = 1/rr1*exp(i*2*pi*rr1/l);
        rr2 = norm(r-r2,2);
        Z2 = 1/rr2*exp(i*2*pi*rr2/l);
        rr3 = norm(r-r3,2);
        Z3 = 1/rr3*exp(i*2*pi*rr3/l);
        rr4 = norm(r-r4,2);
        Z4 = 1/rr4*exp(i*2*pi*rr4/l);
        Z_sph(thcnt, phcnt) = Z0 + Z1 + Z2 + Z3 + Z4;
        if ampcnt == 1 & phacnt == 1
          Z_sph_0(thcnt, phcnt) = Z1 + Z2 + Z3 + Z4;
        end
      end
    end
    Z_sph_abs_mean = mean(mean(abs(Z_sph)));
    if Z_sph_abs_mean < Z_sph_abs_mean_min
      amp_min = amp;
      pha_min = pha;
      Z_sph_abs_mean_min = Z_sph_abs_mean;
      Z_sph_min = Z_sph;
    end
  end
end
figure;
mesh(ph_vec, th_vec, log(abs(Z_sph_0)));
xlabel(‘phi in radians’);
ylabel(‘theta in radians’);
zlabel(‘log amplitude’);
title(‘Uncompensated amplitude on the sphere’);
figure;
mesh(ph_vec, th_vec, log(abs(Z_sph_min)));
xlabel(‘phi in radians’);
ylabel(‘theta in radians’);
zlabel(‘log amplitude’);
title(‘Post-cancellation amplitude on the sphere’);
red_sph_db = 20*log 10(mean(mean(abs(Z_sph_0)))/mean(mean(abs(Z_sph_min))))
% plot lateral x-y plane
for xcnt = 1:x_len
    for ycnt = 1:y_len
    r = [x_vec(xcnt) y_vec(ycnt) 0];
    rr0 = norm(r,2);
    Z0 = amp_min/rr0*exp(i*(2*pi*rr0/l+pha_min));
    rr1 = norm(r-r1,2);
    Z1 = 1/rrl*exp(i*2*pi*rr1/l);
    rr2 = norm(r-r2,2);
    Z2 = 1/rr2*exp(i*2*pi*rr2/l);
    rr3 = norm(r-r3,2);
    Z3 = 1/rr3*exp(i*2*pi*rr3/l);
    rr4 = norm(r-r4,2);
    Z4 = 1/rr4*exp(i*2*pi*rr4/l);
    Z_xy(xcnt, ycnt) = Z1 + Z2 + Z3 + Z4;
    Z_xy_comp(xcnt, ycnt) = Z_xy(xcnt, ycnt) + Z0;
  end
end
figure;
mesh(x_vec, y_vec, log(abs(Z_xy)));
xlabel(‘x coord in meters’);
ylabel(‘y coord in meters’);
zlabel(‘log amplitude’);
title(‘Uncompensated amplitude on the x-y plane’);
figure;
mesh(x_vec, y_vec, log(abs(Z_xy_comp)));
xlabel(‘x coord in meters’);
ylabel(‘y coord in meters’);
zlabel(‘log amplitude’);
title(‘Post-cancellation amplitude on the x-y plane’);
red_xy_db = 20*log10(mean(mean(abs(Z_xy)))/mean(mean(abs(Z_xy_comp))))
% plot vertical x-z plane
for xcnt= 1:x_len
  for zvnt = 1:z_len
    r = [x_vec(xcnt) 0 z_vec(zcnt)];
    rr0 = norm(r,2);
    Z0 = amp_min/rr0*exp(i*(2*pi*rr0/l+pha_min));
    rr1 = norm(r-r1,2);
    Z1 = 1/rrl*exp(i*2*pi*rr1/l);
    rr2 = norm(r-r2,2);
    Z2 = 1/rr2*exp(i*2*pi*rr2/l);
    rr3 = norm(r-r3,2);
    Z3 = 1/rr3*exp(i*2*pi*rr3/l);
    rr4 = norm(r-r4,2);
    Z4 = 1/rr4*exp(i*2*pi*rr4/l);
    Z_xz(xcnt, zcnt) = Z1 + Z2 + Z3 + Z4;
    Z_xz_comp(xcnt, zcnt) = Z_xz(xcnt, zcnt) + Z0;
  end
end
figure;
mesh(x_vec, z_vec, log(abs(Z_xz)));
xlabel(‘x coord in meters’);
ylabel(‘z coord in meters’);
zlabel(‘log amplitude’);
title(‘Uncompesated amplitude on the x-z plane’);
legend;
figure;
mesh(x_vec, z_vec, log(abs(Z_xz_comp)));
xlabel(‘x coord in meters’);
ylabel(‘z coord in meters’);
zlabel(‘log amplitude’);
title(‘Post-cancellation amplitude on the x-z plane’);
red_xz_db = 20*log10(mean(mean(abs(Z_xz)))/mean(mean(abs(Z_xz_comp))))
```

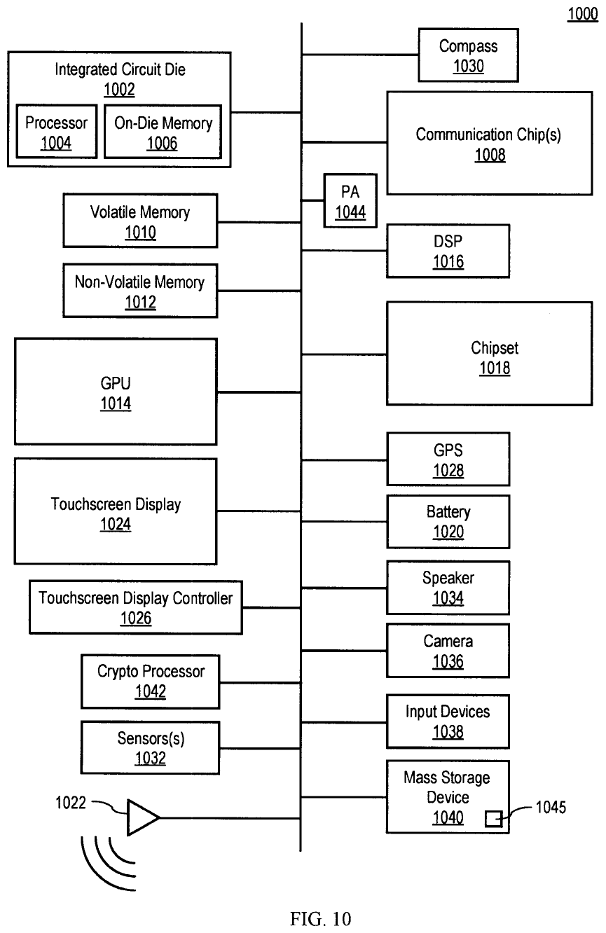

FIG. 10 is a block diagram of a data processing system 1000 in accordance with one embodiment. Data processing system processing 1000 represents any data processing system configured to perform methods to preserve wildlife and enable remote wildlife tourism, as described herein with respect to FIGS. 1-9 and 11, 12A, 12B, 13A, 13B, 14A and 14B. In alternative embodiments, the data processing system 1000 may be connected (e.g., networked) to other machines in a Local Area Network (LAN), an intranet, an extranet, or the Internet. The data processing system 1000 may operate in the capacity of a server or a client machine in a client-server network environment, or as a peer machine in a peer-to-peer (or distributed) network environment. In at least some embodiments, a drone is coupled to data processing system 1000. In at least some embodiments, the drone includes at least a portion of data processing system 1000. In one example, the drone may communicate via a network to other machines or drones.

In at least some embodiments, a data processing system 1000 comprises one or more mechanical control systems (not shown) (e.g., motors, steering control, brake control, throttle control, etc.) and an airbag system (not shown). In at least some embodiments, system 1000 comprises one or more processors that are configured to execute software instructions to perform different features and functionality (e.g., drone driving decisions) and provide a graphic user interface (GUI) on a display device for a user. In one embodiment, the GUI is a touch-screen with an input and output functionality. In one embodiment, the GUI provides a playback through the speaker(s) 1034 and a display system of audio (and other) content to a user. The one or more processors of the system 1000 perform the different features and functionality for an operation of the drone based at least partially on receiving an input from the one or more sensors 1032 and cameras 1036. In one embodiment, the one or more sensors 1032 include one or more LiDAR sensors, one or more radar sensors, one or more ultrasonic sensors, one or more global positioning system (GPS) sensors, additional sensors, or any combination thereof.

The data processing system 1000 may further include a network interface device. The data processing system 1000 may further include a radio frequency (RF) transceiver that provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/dispreading, inverse fast Fourier transforming (IFFT)/fast Fourier transforming (FFT), cyclic prefix appending/removal, and other signal processing functions.

In at least some embodiments, the data processing system 1000 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that data processing system. Further, while only a single data processing system is illustrated, the term “data processing system” shall also be taken to include any collection of data processing systems that individually or jointly execute a set (or multiple sets) of instructions to perform any one or more of the methodologies described herein.

A processor 1004 represents one or more general-purpose processing devices such as a microprocessor, central processing unit, or other processing device. More particularly, the processor 1004 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1004 may also be one or more special-purpose processing devices such as an application specific integrated circuit (ASIC), a field programmable gate array (FPGA), a digital signal processor (DSP), network processor, or the like. Processor 1004 is configured to control a processing logic for performing the operations described herein with respect to FIGS. 1-9.

The data processing system 1000 may include a number of components. In one embodiment, these components are attached to one or more motherboards. In an alternate embodiment, these components are fabricated onto a single system-on-a-chip (SoC) die rather than a motherboard. The components in the data processing system 1000 include, but are not limited to, an integrated circuit die 1002 and at least one communication chip 1008. In some implementations, the communication chip 1008 is fabricated as part of the integrated circuit die 1002. The integrated circuit die 1002 may include processor 1004, an on-die memory 1006, often used as cache memory, that can be provided by technologies such as embedded DRAM (eDRAM) or spin-transfer torque memory (STTM or STTM-RAM).

Data processing system 1000 may include other components that may or may not be physically and electrically coupled to the motherboard or fabricated within an SoC die. These other components include, but are not limited to, a volatile memory 1010 (e.g., DRAM); a non-volatile memory 1012 (e.g., ROM or flash memory); a graphics processing unit 1014 (GPU); a digital signal processor 1016; a crypto processor 1042 (a specialized processor that executes cryptographic algorithms within hardware); a chipset 1018; an antenna 1022; a display or a touchscreen display 1024; a touchscreen controller 1026; a battery 1020 or other power source; a power amplifier (PA) 1044; a global positioning system (GPS) device 1028; a compass 1030; one or more sensors 1032 that may comprise a power sensor to measure the power consumed by a system, a motion sensor, a location sensor, or other sensor; one or more speakers 1034; one or more cameras 1036; user input/output devices 1038 (e.g., a keyboard, mouse, stylus, a touch input, a voice activation device, a set of speakers, etc.); and a mass storage device 1040 (such as hard disk drive, compact disk (CD), digital versatile disk (DVD), and so forth). In one embodiment, the one or more sensors 1032 comprises a set of sensors as described above with respect to FIGS. 1-9.

The communications chip 1008 enables wireless communications for the transfer of data to and from the data processing system 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1008 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The data processing system 1000 may include a plurality of communication chips 1008. For instance, a first communication chip 1008 may be dedicated to shorter range wireless communications such as Wi-Fi and Bluetooth and a second communication chip 1008 may be dedicated to longer range wireless communications such as GPS, EDGE, GPRS, CDMA, WiMAX, LTE, Ev-DO, and others.

The term “processor” may refer to any device or portion of a device that processes electronic data from registers and/or memory to transform that electronic data into other electronic data that may be stored in registers and/or memory.

In various embodiments, the data processing system 1000 may be a laptop computer, a netbook computer, a notebook computer, an ultrabook computer, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the data processing system 1000 may be any other electronic device that processes data.

The mass storage device 1040 may include a machine-accessible storage medium (or more specifically a computer-readable storage medium) 1045 on which is stored one or more sets of instructions (e.g., a software) embodying any one or more of the methodologies or functions described herein. The software may also reside, completely or at least partially, within the memory 1010, memory 1012, memory 1006 and/or within the processor 1004 during execution thereof by the data processing system 1000, the on-die memory 1006 and the processor 1004 also constituting machine-readable storage media. The software may further be transmitted or received over a network via a network interface device.

While the machine-accessible storage medium 1045 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

The following examples pertain to further embodiments:

A system for remote viewing of wildlife may comprise: a set of one or more drones (or blimps) with cameras, or a set of one or more cameras, that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein the user books and/or pays for a certain allotted time and is then given control of the drone by the application server for this allotted time.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein the application server enables a game whereby individuals are scored based on the number and/or type of species or individual organisms that they photograph or identify by other means.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein automatic image recognition or human reviewers are used to classify the species or animals photographed or videotaped.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein human reviewers are used to classify the species or animals photographed or videotaped, and the reviewed data is used to train deep-learning neural networks to classify species or individual animals from images automatically.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, where the drones include location capability and are geo-fenced so that they cannot leave certain boundaries or go below or above certain altitudes.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein the drone is monitored for an allotted time or remaining power and is either automatically flown or flown by a third party back to a base station for recharging.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein the nature viewing application is enabled by the drones being augmented according to one or more of the following: a helium balloon is attached to the drones to effectively decrease the weight and extend flight time; the drone is made quieter so that it does not disturb animals, such as by the drones using propellers that are larger or rotate at different frequencies; the drones include one or more speakers that broadcast sounds that are designed to create destructive interference for the sound emanating from the drone; the drones are surrounded by protective material such a light mesh so as not to damage organisms; the drones are painted colors such as green or blue to blend into the natural environment; the drones include a directional microphone that enables users to hear the noise that is being made by the animals or from whichever direction the direction microphone is being pointed; the drones include a microphone on each drone in combination with audio recognition software that is able to identify the sound of a shot being fired, the use of microphones along with standardized clocks such as GPS enabling multiple drones to triangulate the position from which a shot is fired; the drone is equipped with image processing and flight control for automatic obstacle avoidance; and/or the drone and/or the drone charging station is equipped with equipment that enables automatic docking of the drone for charging.

A system for remote viewing of wildlife may comprise: a set of one or more drones (or blimps) with cameras or a set of one or more cameras that are remotely controlled via the Internet; an application server that enables remote individuals or groups to log onto the drones and/or cameras, issue commands to control the flight of the drones and/or the direction and zoom of the cameras, and enables a web user interface that lets users see what is seen in the cameras and identify different species of animals or plants; and a communication system with a wireless component ranging more than 50 m that connects the drones to the application server, wherein the nature viewing application is enabled by the application server offering one or more of the following functionalities of features: collecting identity information for users such as government issued identification and validating these identities to prevent the use of the system for illegal activities such as poaching; identifying all users who were viewing cameras in the region of a particular incident, such as an animal being shot and contacting those users; a system whereby users can record sightings of suspicious people or activity and send a message to a conservancy to prevent illegal activity such as poaching; a map where users can see their location and/or mark the location of sightings or particular species or individual organisms; educational material to educate users about the species that could be spotted; a process whereby revenues from users booking time on the system is split with the conservancy where the organisms are kept and maintained; a system whereby certain species are scored for users differently than other species, such as an eagle being scored 5 points and a sparrow being scored 1 point; a system for computing scores of species based on the frequency at which the species are sighted; a system wherein the application server communicates with ground staff at the conservancy about location and/or status of drones for ongoing maintenance; a system enabling users to contribute to research on the animals such as by creating movement patterns for certain animals; a system that enables users to control the drone to follow suspicious activity such as possible poachers until ground personnel can arrive at the location of the suspicious persons.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A data processing system for remote wildlife viewing, comprising:
a memory; and
a processor coupled to the memory, wherein the processor is configured to:
control a set of one or more drones with cameras;
enable a user to log onto one or more of the drones to capture one or more wildlife images using one or more of the cameras; and
display the one or more wildlife images on a user device.

2. The data processing system of claim 1, wherein the processor is configured to:
receive one or more commands from the user to control at least one of the one or more of the drones and the one or more of the cameras; and
receive wildlife image data captured by the one or more of the cameras in response to the one or more commands.

3. The data processing system of claim 1, wherein the processor is configured to identify a wildlife organism based on the one or more wildlife images using a neural network technique.

4. The data processing system of claim 1, wherein the processor is configured to enable the user to log onto the one or more of the drones for a predetermined time.

5. The data processing system of claim 1, wherein the processor is configured to assign a score to the user based on the one or more wildlife images.

6. The data processing system of claim 1, wherein the processor is configured to control locations of the drones using a geo-fencing technique.

7. The data processing system of claim 1, wherein the processor is configured to monitor a power of the drones.

8. The data processing system of claim 1, wherein the processor is configured to monitor an allotted flight time of the drones.

9. The data processing system of claim 1, wherein the processor is configured to receive information identifying the user.

10. The data processing system of claim 1, wherein the processor is configured to receive a recorded wildlife image from the user to prevent an illegal activity.

11. The data processing system of claim 1, wherein the processor is configured to generate a map indicating at least one of a location of the user, a location of other users and a location at which the one or more wildlife images are captured.

12. The data processing system of claim 1, wherein the processor is configured to display an educational material associated with the one or more wildlife images on the user device.

13. The data processing system of claim 1, wherein the processor is configured to split a revenue from a user booking time on the system with a conservancy.

14. The data processing system of claim 1, wherein the processor is configured to send data including at least one of a location and a status of the one or more drones to a conservancy.

15. The data processing system of claim 1, wherein the processor is configured to generate a map including a movement pattern of a wildlife organism in an area based on data from the user.

16. The data processing system of claim 1, wherein the processor is further configured to:
receive a request to book a flight at a predetermined time;
receive a selection of a conservation location;
receive a payment for the flight; and
generate a notification about the flight to send to the user.

17. The data processing system of claim 1, wherein the processor is further configured to:
generate a user interface to provide the remote wildlife viewing on the user device.

18. The data processing system of claim 1, wherein the processor is further configured to:
generate a flight tutorial video on the user device.

19. The data processing system of claim 1, wherein the processor is further configured to:
determine that the user is authorized to use the one or more of the drones.

20. The data processing system of claim 1, wherein the processor is further configured to:
generate a map indicating a location of a drone assigned to the user relative to a geo-fenced area.
